(19) United States
(12) Patent Application Publication
(10) Pub. No.: US 2025/0345779 A1
(43) Pub. Date: Nov. 13, 2025

(54) CATALYSTS AND PROCESSES FOR A REVERSE WATER GAS SHIFT REACTION FOR CONVERTING CARBON DIOXIDE TO CARBON MONOXIDE

(71) Applicant: Saudi Arabian Oil Company, Dhahran (SA)

(72) Inventor: Mohammed Al-Daous, Jeddah (SA)

(73) Assignee: Saudi Arabian Oil Company, Dhahran (SA)

(21) Appl. No.: 18/662,304

(22) Filed: May 13, 2024

(51) Int. Cl. B01J 23/78; B01J 21/06; B01J 35/45; B01J 37/03; B01J 37/08; B01J 37/16; B01J 38/02; B01J 38/10; C10K 3/02

(52) U.S. Cl. CPC B01J 23/78; B01J 21/063; B01J 35/45; B01J 37/035; B01J 37/08; B01J 37/16; B01J 38/02; B01J 38/10; C10K 3/026; B01J 2235/15

(57) ABSTRACT

A reverse water gas shift catalyst (RWGS catalyst) for conducting reverse water gas shift reactions to convert carbon dioxide to carbon monoxide includes reduced iron oxide and an alkali metal promoter supported on a solid catalyst support. The solid catalyst support includes a plurality of catalyst support particles, and the reduced iron oxide may have iron having an oxidation state of less than 3. Methods of making the RWGS catalyst and processes for converting carbon dioxide to carbon monoxide using the RWGS catalyst are also disclosed.

### BACKGROUND

### Field

The present disclosure relates to catalysts and processes for converting carbon dioxide to hydrocarbons, in particular, catalysts and processes for conducting reverse water gas shift reactions to convert carbon dioxide to carbon monoxide.

### Technical Background

With rising concerns of climate change and greenhouse gas emissions, carbon dioxide (CO₂) capturing processes can be an avenue for mitigating emissions. Typically, CO₂ captured from large point sources, such as cement factories and biomass power plants, is transported and sequestered in an underground geological formation, so that it does not enter the atmosphere. In some cases, CO₂ can be captured from air. In some cases, the CO₂ captured in such processes can be used as part of a feedstock for creating synthetic fuels

The catalytic reduction of CO₂ into value-added products is a compelling solution for CO₂ mitigation, in particular when using renewable energy. The reverse water gas shift (RWGS) reaction plays a pivotal role among the various CO₂ utilization approaches because the RWGS reaction produces carbon monoxide (CO), and excess hydrogen (H₂) produces synthesis gas or syngas. Syngas is a building block of numerous conversion processes frequently used in industrial refineries for Fischer-Tropsch synthesis and production of alcohols, such as methanol, which is one of the top five chemicals sold worldwide.

### SUMMARY

Accordingly, there is an ongoing need for catalysts and processes for conducting reverse water gas shift (RWGS) reactions to convert carbon dioxide (CO₂) to carbon monoxide. The growing demand for clean fuels and commodities reinforces the significance of highly efficient RWGS processes coupled to CO₂ revalorization. The present disclosure is directed to RWGS catalysts and processes for conducting reverse water gas shift reactions to convert carbon dioxide to carbon monoxide, which can then be used to synthesize hydrocarbons and other chemical products and intermediates through Fischer-Tropsch processes, alcohol synthesis processes, or other chemical reactions using carbon monoxide as a reactant. The RWGS catalyst includes reduced iron oxide and an alkali metal promotor, which are both supported on a solid catalyst support. The iron in the reduced iron oxide has an oxidation state of less than 3. The RWGS catalyst is used in a process for conducting a reverse water gas shift reaction to convert CO₂ to CO and water with a selectivity for CO of greater than or equal to 90% and a conversion of CO₂ of greater than or equal to 10% at reaction temperatures of from 400° C. to 600° C.

According one or more aspects of the present disclosure, a reverse water gas shift catalyst (RWGS catalyst) for conducting reverse water gas shift reactions to convert carbon dioxide to carbon monoxide may comprise reduced iron oxide and an alkali metal promoter supported on a solid catalyst support, where the solid catalyst support may comprise a plurality of catalyst support particles and the reduced iron oxide may have iron having an oxidation state of less than 3.

According to another aspect of the present disclosure, a method of making an RWGS catalyst may comprise precipitating a reduced iron oxide and an alkali metal promoter onto surfaces of a solid catalyst support through deposition reductive precipitation, where the RWGS catalyst may comprise the reduced iron oxide and the alkali metal promotor supported on the solid catalyst support, where the solid catalyst support may comprise a plurality of catalyst support particles and the reduced iron oxide may have iron having an oxidation state of less than 3.

According to still another aspect of the present disclosure, a process for converting carbon dioxide to carbon monoxide may comprise contacting a carbon dioxide stream with hydrogen in the presence of an RWGS catalyst at a reaction temperature of from 350° C. (623 Kelvin (K)) to 600° C. (873 K), where the RWGS catalyst may comprise reduced iron oxide and an alkali metal promoter supported on a solid catalyst support, where the solid catalyst support may comprise a plurality of catalyst support particles and the reduced iron oxide may have iron having an oxidation state of less than 3. The contacting may cause the carbon dioxide in the carbon dioxide stream and the hydrogen to undergo a reverse water gas shift reaction to produce carbon monoxide and water.

Additional features and advantages of the aspects of the present disclosure will be set forth in the detailed description that follows and, in part, will be readily apparent to a person of ordinary skill in the art from the detailed description or recognized by practicing the aspects of the present disclosure.

### BRIEF DESCRIPTION OF THE DRAWINGS

The following detailed description of the present disclosure may be better understood when read in conjunction with the following drawings in which:

FIG. 1 schematically depicts a generalized flow diagram of a fixed bed reactor system for conducting a RWGS reaction to convert CO₂ to CO, according to one or more embodiments shown and described in the present disclosure;

FIG. 2 depicts a flowchart of a process for producing a reverse water gas shift catalyst (RWGS catalyst), according to one or more embodiments shown and described in the present disclosure;

FIG. 3 schematically depicts a generalized flow diagram of another fixed bed reactor system for conducting a RWGS reaction to convert CO₂ to CO, according to one or more embodiments shown and described in the present disclosure;

FIG. 4 schematically depicts a generalized flow diagram of still another fixed bed reactor system for conducting a RWGS reaction to convert CO₂ to CO, according to one or more embodiments shown and described in the present disclosure;

FIG. 5 graphically depicts X-ray diffraction spectra for a sodium titanate (NaTiNT) support for an RWGS catalyst, according to one or more embodiments shown and described in the present disclosure;

FIG. 6 graphically depicts rates of hydrogen uptake (y-axis) as a function of temperature (x-axis) for RWGS catalysts having different catalyst support materials, according to one or more embodiments shown and described in the present disclosure;

FIG. 7 graphically depicts CO₂ conversion (y-axis) as a function of time on stream (x-axis) at different temperatures for an RWGS reaction conducted using an RWGS catalyst comprising Fe-K on a catalyst support comprising sodium titanate, according to one or more embodiments shown and described in the present disclosure;

FIG. 8 graphically depicts CO selectivity (y-axis) as a function of time on stream (x-axis) at two different temperatures for an RWGS reaction conducted using an RWGS catalyst comprising Fe-K on a catalyst support comprising sodium titanate, according to one or more embodiments shown and described in the present disclosure;

FIG. 9 graphically depicts CO₂ conversion (y-axis) as a function of reaction temperature (x-axis) for two different molar ratios of H₂ to CO₂ used to conduct an RWGS reaction conducted using an RWGS catalyst comprising Fe-K on a catalyst support comprising sodium titanate, according to one or more embodiments shown and described in the present disclosure;

FIG. 10 graphically depicts CO₂ conversion (y-axis) as a function of time on stream (x-axis) for RWGS reactions conducted using RWGS catalysts comprising different amounts of Fe-K supported on sodium titanate, according to one or more embodiments shown and described in the present disclosure; and

FIG. 11 graphically depicts CO₂ conversion (y-axis) as a function of time on stream (x-axis) for RWGS reactions conducted using RWGS catalysts comprising Fe-K supported on different types of catalyst supports according to one or more embodiments shown and described in the present disclosure.

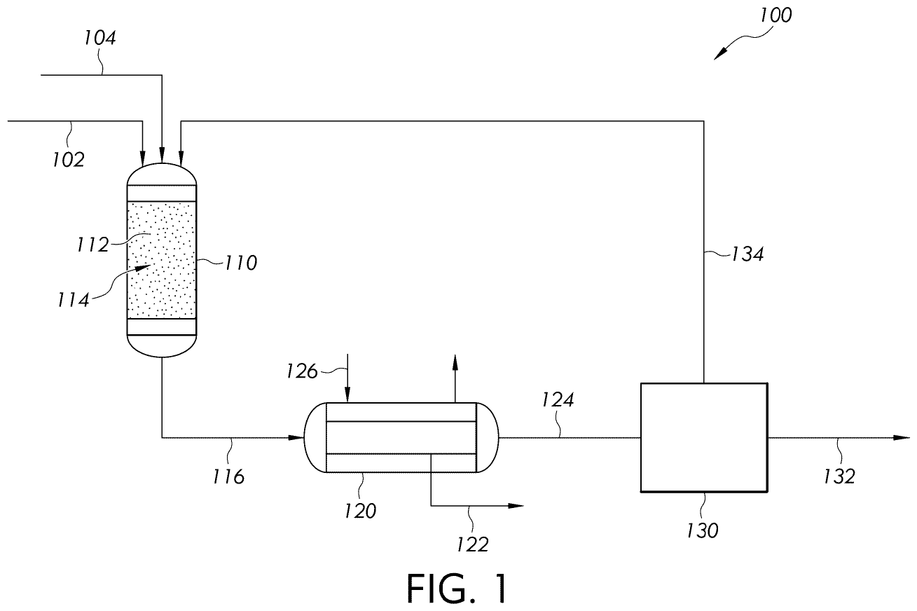

When describing the simplified schematic illustrations of FIGS. 1, 3, and 4 the numerous valves, temperature sensors, electronic controllers, and the like, which may be used and are well known to a person of ordinary skill in the art, may not be included. Further, accompanying components that are often included in systems such as those depicted in FIGS. 1, 3, and 4, such as air supplies, heat exchangers, surge tanks, and the like also may not be included. However, a person of ordinary skill in the art understands that these components are within the scope of the present disclosure.

Additionally, the arrows in the simplified schematic illustrations of FIGS. 1, 3, and 4 refer to process streams. However, the arrows may equivalently refer to transfer lines, which may transfer process streams between two or more system components. Arrows that connect to one or more system components signify inlets or outlets in the given system components and arrows that connect to only one system component signify a system outlet stream that exits the depicted system or a system inlet stream that enters the depicted system. The arrow direction generally corresponds with the major direction of movement of the process stream or the process stream contained within the physical transfer line signified by the arrow.

The arrows in the simplified schematic illustrations of FIGS. 1, 3, and 4 may also refer to process steps of transporting a process stream from one system component to another system component. For example, an arrow from a first system component pointing to a second system component may signify “passing” a process stream from the first system component to the second system component, which may comprise the process stream “exiting” or being “removed” from the first system component and “introducing” the process stream to the second system component.

Reference will now be made in greater detail to various aspects, some of which are illustrated in the accompanying drawings.

### DETAILED DESCRIPTION

The present disclosure is directed to reverse water gas shift catalysts (RWGS catalyst) and processes for conducting reverse water gas shift reactions for converting carbon dioxide (CO₂) to carbon monoxide (CO), which can be used as a reactant to produce hydrocarbons or other chemical products and intermediates. The RWGS catalysts of the present disclosure may comprise iron oxide and an alkali metal promoter supported on a solid catalyst support, where the solid catalyst support comprises a plurality of catalyst support particles and the iron oxide is a reduced iron oxide in which the iron in the reduced iron oxide has an oxidation state of less than 3. Processes for producing the RWGS catalyst are also disclosed.

Referring now to FIG. 1, one embodiment of a system 100 for conducting the processes of present disclosure to convert CO₂ to CO using the RWGS catalyst is schematically depicted. The system 100 may include a reactor 110 comprising the RWGS catalyst 112 disposed in a reaction zone 114 of the reactor 110. The system 100 may also include a condenser 120 and a product separation system 130, both of which are disposed downstream of the reactor 110. Processes disclosed herein for converting carbon dioxide to carbon monoxide may comprise contacting a CO₂ stream 102 with hydrogen 104 in the presence of the RWGS catalyst 112 at a temperature of from 400 degrees Celsius (° C.) (673 Kelvin (K)) to 600° C. (873 K). The contacting causes the CO₂ in the CO₂ stream 102 and the hydrogen 104 to undergo a reverse water gas shift reaction to produce CO and water. The processes may have a high selectivity for CO, such as a CO selectivity of greater than 90%, at reaction temperatures of from 400° C. to 800° C. The processes may also have a relatively high conversion of CO₂, such as a conversion of greater than about 40% at temperatures of from 400° C. to 600° C.

As used in the present disclosure, the term “catalyst” refers to any substance that increases the rate of a specific chemical reaction, such as but not limited to the RWGS reaction, compared to the reaction rate of the chemical reaction without the catalyst.

As used in the present disclosure, the term “used catalyst” refers to catalyst that has been contacted with reactants at reaction conditions, but has not been regenerated in a regenerator or through a regeneration process.

As used in the present disclosure, the term “regenerated catalyst” refers to catalyst that has been contacted with reactants at reaction conditions and then regenerated in a regenerator or regenerated through an in-place regeneration process.

As used in the present disclosure, passing a stream or effluent from one unit “directly” to another unit refers to passing the stream or effluent from the first unit to the second unit without passing the stream or effluent through an intervening reaction system or separation system that substantially changes the composition of the stream or effluent. Heat transfer devices, such as heat exchangers, preheaters, coolers, or other heat transfer equipment, and pressure devices, such as pumps, pressure regulators, compressors, or other pressure devices, are not considered to be intervening systems that change the composition of a stream or effluent, unless otherwise indicated. Combining two streams or effluents together also is not considered to comprise an intervening system that changes the composition of one or both of the streams or effluents being combined.

As used in the present disclosure, the terms “downstream” and “upstream” refer to the positioning of components or unit operations of the processing system relative to a direction of flow of materials through the processing system. For example, a second component is considered “downstream” of a first component if materials flowing through the processing system encounter the first component before encountering the second component. Likewise, the first component is considered “upstream” of the second component if the materials flowing through the processing system encounter the first component before encountering the second component.

As used in the present disclosure, the term “effluent” refers to a stream that is passed out of a reactor, a reaction zone, or a separator following a particular reaction or separation. Generally, an effluent has a different composition than the stream that entered the reactor, reaction zone, or separator. It should be understood that when an effluent is passed to another component or system, only a portion of that effluent may be passed, unless otherwise stated. For example, a slipstream or bleed stream may carry some of the effluent away, meaning that only a portion of the effluent may enter the downstream component or system. The terms “reaction effluent” and “reactor effluent” particularly refer to a stream that is passed out of a reactor or a reaction zone.

As used in the present disclosure, the term “residence time” refers to the amount of time that reactants are in contact with a catalyst, at reaction conditions, such as at the reaction temperature.

As used in the present disclosure, the term “reactor” refers to any vessel, container, conduit, or the like, in which one or more chemical reactions, such as but not limited catalytic cracking reactions, may occur between one or more reactants optionally in the presence of one or more catalysts. One or more “reaction zones” may be disposed within a reactor. The term “reaction zone” refers to a volume where a particular chemical reaction takes place in a reactor.

As used in the present disclosure, the terms “separation system,” “separation unit,” and “separator” all refer to any separation device or collection of separation devices that at least partially separates one or more chemical constituents in a mixture from one another. For example, a separation system selectively separates different chemical constituents from one another, forming one or more chemical fractions. Examples of separation systems include, without limitation, distillation columns, cryogenic distillation units, fractionators, flash drums, knock-out drums, knock-out pots, condensers, centrifuges, decanters, filtration devices, traps, scrubbers, expansion devices, membranes, solvent extraction devices, adsorption devices, pressure swing adsorption units, chemical separators, crystallizers, chromatographs, precipitators, evaporators, driers, high-pressure separators, low-pressure separators, or combinations or these. The separation processes described in the present disclosure may not completely separate all of one chemical constituent from all of another chemical constituent. Instead, the separation processes described in the present disclosure “at least partially” separate different chemical constituents from one another and, even if not explicitly stated, separation can include only partial separation.

It should further be understood that streams may be named for the components of the stream, and the component for which the stream is named may be the major constituent of the stream. The major constituent of a stream is the constituent comprising the greatest fraction of the stream, excluding inert diluent gases, such as nitrogen, noble gases, and the like unless otherwise stated. It should also be understood that components of a stream are disclosed as passing from one system component to another when a stream comprising that component is disclosed as passing from that system component to another. For example, a disclosed “carbon dioxide stream” passing to a first system component or from a first system component to a second system component should be understood to equivalently disclose “carbon dioxide” passing to the first system component or passing from a first system component to a second system component.

RWGS reaction can be regarded as a process in itself to capture CO₂ and convert the CO₂ to CO, or the RWGS reaction can be an intermediate reaction in other CO₂ conversion processes. The RWGS reaction is provided in EQU 1.

$${CO}_{2} + {H}_{2} ⇔ CO + {H}_{2} O \qquad EQU . 1$$

For instance, the RWGS reaction can be a first step in production of hydrocarbons from CO₂ and hydrogen by conducting the RWGS reaction to produce CO followed by conducting a Fischer-Tropsch reaction to convert the CO and H₂ (syngas) to hydrocarbon compounds. In some instances, the conversion of CO₂ to methane (CH₄), methanation, can occur through a consecutive reaction pathway where the RWGS reaction is the first step. During the RWGS reaction, the CO reaction product may undergo further hydrogenation reactions to produce methane, which is a facial and energetically favorable reaction because of the higher reactivity of the CO molecule. Hence, CO₂ methanation is considered to represent the main side reaction affecting the RWGS reaction process selectivity under atmospheric pressure. Therefore, there is a need for effective and selective RWGS catalysts for producing CO via the RWGS reaction to minimize the formation of side reaction products, such as methane.

The RWGS reaction is an equilibrium reaction favored at higher temperatures due to its moderately endothermic character, as well as at high H₂:CO₂ ratios and lower contact times. The thermodynamics of the RWGS reaction indicates that CO becomes the major product at temperatures above 700° C. (973 K). However, the high reaction temperatures of greater than or equal to 700° C. can lead rapid reduction in catalyst activity and reactor service life. For instance, temperatures in excess of 700° C. can lead to the undesired effect of catalyst sintering and can cause damage to the reactor system through corrosion or temperature cycling. Therefore, there is a need for RWGS catalysts capable of producing CO at high selectivity and conversion at moderate temperatures to reduce degradation in catalyst activity, damage to the reactor system, or both.

The present disclosure is directed to RWGS catalysts and processes that solve these problems experienced by conventional catalysts and processes. The RWGS catalysts of the present disclosure are supported-iron based RWGS catalyst capable of hydrogenating CO₂ to produce CO with selectivity of from 90% to 100% at moderate temperatures (400° C. to 600° C.) and H₂:CO₂ feed ratio of from 1 to 5. In particular, the RWGS catalyst of the present disclosure, in its active form, may comprise reduced iron oxide in combination with an alkali metal promoter supported on a solid catalyst support. The alkali metal promoter may include an alkali metal selected from the group consisting of lithium (Li), sodium (Na), potassium (K), rubidium (Rb), caesium (Cs), and combinations thereof. The RWGS catalysts of the present disclosure may provide high selectivity to CO at moderate temperatures of from 400° C. to 600° C. to reduce the production of side reaction products and reduce or prevents rapid loss of catalyst activity from sintering and damage to the reactor system from corrosion, exposure to high temperatures, or thermal cycling.

The RWGS catalyst of the present disclosure may produce a relatively high conversion of CO₂ of up to about 60%, such as from about 10% to 60%, at reaction temperatures of from 400° C. to 600° C. The CO selectivity achieved by the RWGS catalyst can be up to about 100%, such as from 90% to 100%, at the reaction temperatures of from 400° C. to 600° C. The RWGS catalysts of the present disclosure may also provide stable performance for operation of time on stream of greater than 48 hours. Additionally, reactors for the conducting the RWGS reaction with the RWGS catalysts of the present disclosure can be easily integrated into the current existing infrastructure in any heavy carbon industry, such as but not limited to cement making, steel production, hydrocarbon refineries, energy production, or other heavy carbon producing industry.

As previously discussed, the RWGS catalyst of the present disclosure may comprise iron oxide and an alkali metal promoter supported on a solid catalyst support, where the solid catalyst support comprises a plurality of catalyst support particles and the iron oxide is a reduced iron oxide in which the iron in the iron oxide has an oxidation state of less than 3. The catalyst support may comprise sodium titanate (NaHTiO₃), potassium titanate (KHTiO₃), zirconia (ZrO₂), alumina (Al₂O₃), titania (TiO₂), silica (SiO₂), magnesia (MgO), ceria (CeO₂), bentonite clay (H₂Al₂O₆Si), or combinations thereof.

In embodiments, the solid catalyst support may be selected from the group consisting of sodium titanate, potassium titanate, and combinations thereof. In embodiments, the solid catalyst support may be sodium titanate, potassium titanate, or a combination of both. In embodiments, the solid catalyst support may be titanate nanotubes. In embodiments, the solid catalyst support may be sodium titanate nanotubes having from 1.5 wt. % to 20 wt. % sodium based on the total weight of the solid catalyst support particles. The sodium titanate nanotubes may have a specific surface area of from 300 meters squared per gram (m²/g) to 350 m²/g, as determined according to the Burnauer-Emmett-Teller (BET) method of determining specific surface area.

In embodiments, the solid catalyst support may be silica catalyst support particles, which may include, but is not limited to, MCM48 fine powder silica available from Sigma Aldrich. In embodiments, the solid catalyst support may be gamma-alumina (γ-Al₂O₃), which may include, but is not limited to, γ-Al₂O₃ available from Thermo Fischer Scientific. In embodiments, the solid catalyst support may be titania, which may include, but is not limited to, anatase-TiO₂ available from Thermo Fischer Scientific. In embodiments, the solid catalyst support may be zirconia, which may include, but is not limited to, ZrO₂ available from Thermo Fischer Scientific. In embodiments, the solid catalyst support may be ceria, which may include, but is not limited to, CeO₂ fine powder available from Sigma Aldrich. In embodiments, the solid catalyst support may be magnesia (MgO), which may include, but is not limited to, EMSURE® MgO available from Millipore Sigma of Burlington, MA. In embodiments, the solid catalyst support may be bentonite clay, which may include, but is not limited to, bentonite clay obtained from Sigma Aldrich.

The RWGS catalyst of the present disclosure may be prepared using a method of reductive deposition precipitation which comprises depositing reduced iron oxide on surface of solid catalyst support. The reduced iron oxide may refer to iron oxides in which the iron has an oxidation state of less than 3. In embodiments, the reduced iron oxide may be Fe₃O₄. The reduced iron oxide may be deposited on surfaces of the solid catalyst support, such as outer surfaces, pore surfaces, or both of the solid catalyst support. The RWGS catalyst may include from 4 wt. % to 14 wt. % of the reduced iron oxide based on the total weight of the RWGS catalyst. In embodiments, the RWGS catalyst may include from 4 wt. % to 12 wt. %, from 4 wt. % to 10 wt. %, from 4 wt. % to 8 wt. %, from 4 wt. % to 6 wt. %, from 4 wt. % to 5 wt. %, from 5 wt. % to 14 wt. %, 5 wt. % to 12 wt. %, from 5 wt. % to 10 wt. %, from 5 wt. % to 8 wt. %, from 5 wt. % to 6 wt. %, from 6 wt. % to 14 wt. %, 6 wt. % to 12 wt. %, from 6 wt. % to 10 wt. %, from 6 wt. % to 8 wt. %, from 8 wt. % to 14 wt. %, from 8 wt. % to 12 wt. %, from 8 wt. % to 10 wt. %, from 10 wt. % to 14 wt. %, from 10 wt. % to 12 wt. %, or from 12 wt. % to 14 wt. % of the reduced iron oxide based on the total weight of the RWGS catalyst.

The RWGS catalyst may further include the alkali metal promoter deposited on the surfaces of the solid catalyst support, such as on the outer surfaces, pore surfaces, or both of the solid catalyst support. The alkali metal promoter may comprise an alkali metal selected from the group consisting of lithium (Li), sodium (Na), potassium (K), rubidium (Rb), cesium (Cs), and combinations of these. In embodiments, the alkali metal promotor may comprise potassium. In embodiments, the alkali metal promoter may be an alkali metal oxide comprising an alkali metal selected from the group consisting of Li, Na, K, Rb, Cs, and combinations thereof. In embodiments, the alkali metal promoter may comprise an alkali metal oxide selected from the group consisting of Li₂O, Na₂O, K₂O, Rb₂O, Cs₂O, and combinations thereof. In embodiments, the alkali metal promotor may be potassium oxide (K₂O). In embodiments, the alkali metal promoter may be the alkali metal deposited on the surfaces of the solid catalyst support particles.

The RWGS catalyst may have from 4 wt. % to 20 wt. % of the alkali metal promoter based on the total weight of the RWGS catalyst. In embodiments, the RWGS catalyst may include from 4 wt. % to 18 wt. %, from 4 wt. % to 16 wt. %, from 4 wt. % to 14 wt. %, from 4 wt. % to 12 wt. %, from 4 wt. % to 10 wt. %, from 4 wt. % to 8 wt. %, from 4 wt. % to 6 wt. %, from 4 wt. % to 5 wt. %, from 5 wt. % to 20 wt. %, from 5 wt. % to 18 wt. %, from 5 wt. % to 16 wt. %, from 5 wt. % to 14 wt. %, 5 wt. % to 12 wt. %, from 5 wt. % to 10 wt. %, from 5 wt. % to 8 wt. %, from 5 wt. % to 6 wt. %, from 6 wt. % to 20 wt. %, from 6 wt. % to 18 wt. %, from 6 wt. % to 16 wt. %, from 6 wt. % to 14 wt. %, 6 wt. % to 12 wt. %, from 6 wt. % to 10 wt. %, from 6 wt. % to 8 wt. %, from 8 wt. % to 20 wt. %, from 8 wt. % to 18 wt. %, from 8 wt. % to 16 wt. %, from 8 wt. % to 14 wt. %, from 8 wt. % to 12 wt. %, from 8 wt. % to 10 wt. %, from 10 wt. % to 20 wt. %, from 10 wt. % to 18 wt. %, from 10 wt. % to 16 wt. %, from 10 wt. % to 14 wt. %, from 10 wt. % to 12 wt. %, from 12 wt. % to 20 wt. %, from 12 wt. % to 18 wt. %, from 12 wt. % to 16 wt. %, from 12 wt. % to 14 wt. %, from 14 wt. % to 20 wt. %, from 14 wt. % to 18 wt. %, from 14 wt. % to 16 wt. %, from 16 wt. % to 20 wt. %, or from 16 wt. % to 18 wt. % of the alkali metal promoter based on the total weight of the RWGS catalyst.

The RWGS catalyst of the present disclosure is also free of chromium, meaning that chromium is not purposely added to the RWGS catalyst and is present only in trace amounts introduced as an impurity in reagents and minerals used in production of the RWGS catalyst. Any chromium in the RWGS is present in trace amounts as an impurity in reagents used to produce the RWGS catalyst, such as trace chromium in water sources used in making the RWGS catalyst or trace chromium in mineral compounds used to synthesize the catalyst support material. In embodiments, the RWGS catalyst may have less than 3 ppmw chromium, or even less than 1 ppmw chromium.

The RWGS catalyst may comprise RWGS catalyst particles having an average particle size in a range of from about 200 micrometer (μm) to about 500 μm.

In embodiments, the RWGS catalyst may comprise the solid catalyst support selected from the group consisting of sodium titanate, potassium titanate, zirconia (ZrO₂), alumina (Al₂O₃), titania (TiO₂), silica (SiO₂), magnesia (MgO), ceria (CeO₂), bentonite clay, and combinations thereof; from 4 wt. % to 14 wt. % of the reduced iron oxide based on the total weight of the RWGS catalyst, where the iron in the reduced iron oxide has an oxidation state of less than 3; and from 4 wt. % to 20 wt. % of the alkali metal promoter based on the total weight of the RWGS catalyst, where the alkali metal promotor comprises an alkali metal selected from the group consisting of Li, Na, K, Rb, Cs, and combinations thereof; where the reduced iron oxide and the alkali metal promoter are deposited on surfaces of the solid catalyst support. In embodiments, the RWGS catalyst may comprise, consist of, or consist essentially of the solid catalyst support selected from sodium titanate, potassium titanate, zirconia, alumina, titania, silica, magnesia, ceria, bentonite clay and combinations thereof; from 4 wt. % to 14 wt. % of the reduced iron oxide, where the iron of the reduced iron oxide has an oxidation state of less than 3; and from 4 wt. % to 20 wt. % of the alkali metal promoter, where the alkali metal promoter comprises potassium; where the reduced iron oxide and the alkali metal promoter are deposited on surfaces of the solid catalyst support. In embodiments, the RWGS catalyst may comprise, consist of, or consist essentially of the solid catalyst support, where the solid catalyst support comprises sodium titanate nanotubes or potassium titanate nanotubes; from 4 wt. % to 14 wt. % of the reduced iron oxide based on the total weight of the RWGS catalyst, where the iron in the reduced iron oxide has an oxidation state of less than 3; and from 4 wt. % to 20 wt. % of the alkali metal promoter based on the total weight of the RWGS catalyst, where the alkali metal promotor comprises an alkali metal selected from the group consisting of Li, Na, K, Rb, Cs, and combinations thereof; where the reduced iron oxide and the alkali metal promoter are deposited on surfaces of the solid catalyst support.

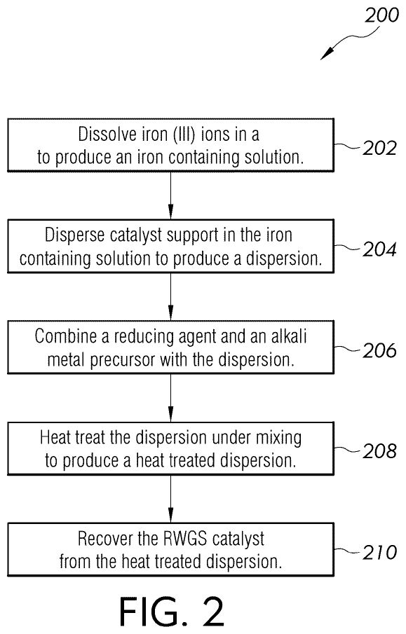

The RWGS catalyst may be prepared using a method of deposition reductive precipitation, during which iron (III) ions with oxidation state of 3 dissolved in a solution is reduced to an oxidation state of less than 3 and simultaneously deposited onto the surfaces of the solid catalyst support. Referring now to FIG. 2, a flowchart for one embodiment of a method 200 for preparing the RWGS catalyst of the present disclosure is depicted. The method 200 may include dissolving iron (III) ions in a solvent to produce an iron-containing solution in step 202, dispersing the solid catalyst support particles in the iron-containing solution to produce a dispersion in step 204, combining a reducing agent and an alkali metal precursor with the dispersion in step 206, and heat treating the dispersion with the reducing agent and the alkali metal precursor in step 208. In step 208, the heat treating may include heat treating the dispersion with the reducing agent and the alkali metal precursor at a temperature and for a time sufficient to reduce the iron to produce a reduced iron oxide in which the iron has an oxidation state less than 3 and precipitate the reduced iron oxide and alkali metal precursor onto surfaces of the catalyst support particles. The method 200 may further include recovering the RWGS catalyst from the heat-treated dispersion in step 210. In embodiments, the method may further include synthesizing the solid catalyst support particles.

In the first step 202 of preparing the RWGS catalyst, the iron (III) ions may be dissolved in the solvent by combining an iron precursor and a solvent to produce an iron-containing solution. The iron precursor may be an iron salt comprising iron having an oxidation state of greater than or equal to 3, such as but not limited to iron sulfate, iron chloride, iron acetate, iron nitrate, iron acetylacetonate, or combinations of these iron precursors. In embodiments, the iron precursor may be an iron salt selected from the group consisting of iron (III) sulfate, iron (III) chloride, iron (III) acetate, iron (III) nitrate, iron (III) acetylacetonate, and combinations of these iron salts. The solvent may include but is not limited to ethylene glycol, diethylene glycol, triethylene glycol, butanol, pentanol, hexanol, benzyl alcohol, or combinations of these solvents. In embodiments, the solvent may be selected from the group consisting of ethylene glycol, diethylene glycol, triethylene glycol, butanol, pentanol, hexanol, benzyl alcohol, and combinations of these solvents.

Combining the iron precursor and the solvent to produce the iron-containing solution in Step 202 may include adding the iron precursor to a volume of the solvent and then mixing to produce the iron-containing solution, which is a homogeneous solution comprising iron (III) ions dissolved in the solvent. The iron-containing solution may include an amount of the iron precursor sufficient to produce the RWGS catalyst having from 4 wt. % to 14 wt. % reduced iron oxide based on the total weigh of the RWGS catalyst. In embodiments, the iron-containing solution may comprise equivalent amounts of iron ranging from 0.5 wt. % to 10 wt. %, from 1 wt. % to 5 wt. %, from 1 wt. % to 4.5 wt. %, from 1 wt. % to 4 wt. %, from 1 wt. % to 3.5 wt. %, from 1.5 wt. % to 5 wt. %, from 1.5 wt. % to 4.5 wt. %, from 1.5 wt. % to 4 wt. %, or from 1.5 wt. % to 3.5 wt. % of the total weight of the RWGS catalyst. After adding the iron precursor to the solvent, the iron-containing solution may be mixed at a temperature and time sufficient to dissolve the iron precursor in the solvent. In embodiments, the iron-containing solution may be mixed by stirring at a temperature of from 50° C. to 100° C., such as from 50° C. to 90° C., from 60° C. to 100° C., from 60° C. to 90° C., from 70° C. to 100° C., from 70° C. to 90° C., of from 80° C. to 100° C. The mixing time for Step 202 of method 200 may be from 15 minutes to 2 hours, such as from 15 minutes to 1 hours, from 30 minutes to 2 hours, or from 30 minutes to 1 hour.

Referring again to FIG. 2, as previously discussed, the method 200 of making the RWGS catalyst includes dispersing the solid catalyst support particles in the iron-containing solution to produce the dispersion in Step 204. The solid catalyst support particles may be any of the materials described herein for the solid catalyst support, such as but not limited to sodium titanate, potassium titanate, zirconia, alumina, titania, silica, magnesia, ceria, bentonite clay, or combinations of these solid catalyst supports. Dispersing the solid catalyst support particles in the iron-containing solution may include adding the solid catalyst support particles to the iron-containing solution and then mixing at a mixing temperature and for a mixing time sufficient to disperse the solid catalyst support particles in the iron-containing solution to produce the dispersion. In embodiments, after adding the solid catalyst support particles, the dispersion may be mixed through vigorous stirring at a temperature of from 50° C. to 100° C., such as from 50° C. to 90° C., from 60° C. to 100° C., from 60° C. to 90° C., from 70° C. to 100° C., from 70° C. to 90° C., of from 80° C. to 100° C. The mixing time for Step 204 of method 200 may be from 30 minutes to 4 hours, such as from 30 minutes to 3 hours, from 30 minutes to 2 hours, from 1 hour to 4 hours, from 1 hour to 3 hours, from 1 hour to 2 hours, from 1.5 hours to 4 hours, from 1.5 hours to 3 hours, from 1.5 hours to 2 hours, from 2 hours to 4 hours, or from 2 hours to 3 hours. Following Step 204, in embodiments, the dispersion may be allowed to cool back to room temperature (from 18-25° C., or about 20° C.).

In embodiments, the methods for making the RWGS catalyst may include synthesizing the solid catalyst support particles. In embodiments, the solid catalyst support particles may be an alkali metal titanate, such as sodium titanate, potassium titanate, or both, and the method of making the RWGS may include synthesizing the alkali metal titanate catalyst support. In embodiments, synthesizing the alkali metal titanate may include dispersing titania (TiO₂) particles in de-ionized water; stirring at room temperature for 30 minutes to produce a titania dispersion; adding alkali metal hydroxide, such as NaOH or KOH, dropwise to the titania dispersion under vigorous stirring; stirring the mixture at room temperature for about 2 hours; and heating the mixture in an autoclave at a temperature of about 140° C. for about 60 hours. Following the heating, the mixture may be allowed to cool to room temperature and the solid product separated from the liquids by filtration. The solid product may then be washed with de-ionized water. The solid product may be re-dispersed in de-ionized water and the pH adjusted to a pH of less than 7, such as about 5. The resulting alkali metal titanate catalyst support particles are then filtered, washed, and dried. The alkali metal titanate catalyst support particles may include from 1.5 wt. % to 20 wt. % of the alkali metal based on the total weight of the alkali metal titanate catalyst support particles.

Referring again to FIG. 2, in Step 206, the method 200 may further include combining the reducing agent and the alkali metal precursor with the dispersion. Combining the reducing agent and the alkali metal precursor with the dispersion may be conducted after producing the dispersion by adding the catalyst support particles to the iron-containing solution. The reducing agent may be selected from the group consisting of hydrazine monohydrate, sodium borohydride, butanol, pentanol, hexanol, benzyl alcohol, and combinations thereof. In embodiments, the solvents may include solvents that also serve as reducing agents, such as but not limited to butanol, pentanol, hexanol, benzyl alcohol, or combinations thereof. The amount of reducing agent added to the dispersion may be sufficient to reduce the iron (III) ions to an oxidation state of less than 3. In embodiments, a molar ratio of the reducing agent to the iron precursor may be greater than 1, such as from 1 to 10, from 1 to 8, from 1 to 6, from 2 to 10, from 2 to 8, from 2 to 6, from 2.5 to 10, from 2.5 to 8, or from 2.5 to 6, where the molar ratio of reducing agent to iron precursor is equal to the moles of reducing agent divided by the moles of iron precursor in the dispersion. After adding the reducing agent, the dispersion may be mixed at room temperature (18-25° C. or about 20° C.) for about 5 minutes before adding the alkali metal precursor.

The alkali metal precursor may comprise sodium hydroxide, potassium hydroxide, lithium hydroxide, rubidium hydroxide, caesium hydroxide, potassium benzoate, potassium acetylacetonate, potassium acetylide, potassium acetyl aminosuccinate, or combinations of these alkali metal precursors. In embodiments, the alkali metal precursor may be an alkali metal hydroxide, such as but not limited to lithium hydroxide, sodium hydroxide, potassium hydroxide rubidium hydroxide, caesium hydroxide, or combinations of these alkali metal hydroxides. In embodiments, the alkali metal precursor may be sodium hydroxide, potassium hydroxide, or both.

The dispersion may include an amount of the alkali metal precursor sufficient to produce the RWGS catalyst having from 4 wt. % to 20 wt. % of the alkali metal promoter based on the total weigh of the RWGS catalyst. In embodiments, the dispersion may comprise from 0.5 wt. % to 10 wt. %, from 1 wt. % to 5 wt. %, from 1 wt. % to 4.5 wt. %, from 1 wt. % to 4 wt. %, from 1 wt. % to 3.5 wt. %, from 1.5 wt. % to 5 wt. %, from 1.5 wt. % to 4.5 wt. %, from 1.5 wt. % to 4 wt. %, or from 1.5 wt. % to 3.5 wt. % of the alkali metal precursor based on the total weight of the dispersion. In embodiments, the dispersion is not stirred after adding the alkali metal precursor.

Referring again to FIG. 2, after adding the reducing agent and the alkali metal precursor, the method includes heat treating the dispersion at a heat treatment temperature and for a heat treatment time sufficient to reduce the iron (III) ions to produce a reduced iron oxide in which the iron has an oxidation state less than 3. Heat treating the dispersion further precipitates the reduced iron oxide and alkali metal onto surfaces of the catalyst support particles to produce a heat-treated dispersion comprising the RWGS catalyst. The heat treatment temperature may be greater than or equal to 120° C., such as from 120° C. to 200° C., from 120° C. to 180° C., from 120° C. to 170° C., from 140° C. to 200° C., from 140° C. to 180° C., from 140° C. to 170° C., from 150° C. to 200° C., from 150° C. to 180° C., from 150° C. to 170° C., from 160° C. to 200° C., from 160° C. to 180° C., from 160° C. to 170° C., or from 170° C. to 200° C. The heat treatment time may be from 24 hours to 48 hours. The heat treating the dispersion may further include mixing or agitating the dispersion during the heat treating. In embodiments, the heat treating the dispersion may be conducted in an autoclave or a glass vessel. In embodiments, the heat treating may be conducted in a TEFLON©-lined stainless-steel autoclave. When heat treating is conducted in an autoclave, the dispersion may be mixed or agitated during the heat treating by mechanically tumbling the autoclave. When heat treating is conducted in a glass vessel, the dispersion may be mixed or agitated using a mixer, magnetic stir bar, or other type of device capable to mixing the contents of the glass vessel.

Referring again to FIG. 2, following the heat treating in Step 208, the methods 200 may further include recovering the RWGS catalyst from the heat-treated dispersion in Step 210. Recovering the RWGS catalyst may include separating the RWGS catalyst from the mother liquor of the dispersion through filtration; washing the RWGS catalyst with an alcohol, such as but not limited to ethanol, isopropanol, or both; and then drying the RWGS catalyst. Separating the RWGS catalyst from the mother liquor may include filtering the heat-treated dispersion by any known filtration method. After washing the RWGS catalyst with the alcohol, the RWGS catalyst may be subjected to a second filtering operation. During the second filtering operation, the RWGS catalyst may be filtered to dryness at room temperature (18° C. to 25° C., or about 20° C.). Dryness may correspond to a liquid content of less than or equal to 10 wt. % based on the total weight of the filtered RWGS catalyst.

Following recovering the RWGS catalyst from the heat-treated dispersion in Step 210 of method 200, in embodiments, the method 200 may further include drying the RWGS to remove additional liquids from the RWGS catalyst. In embodiments, the method may include drying the RWGS catalyst under vacuum at a drying temperature of from 50° C. to 100° C., or about 85° C. for a drying period of from 24 hours to 48 hours. In embodiments, vacuum drying the RWGS catalyst may be conducted in a vacuum oven.

The RWGS catalyst obtained from the method 200 may be a solid catalyst comprising the reduced iron oxide and the alkali metal promoter supported on the solid catalyst support particles, where the iron of the iron oxide has a reduced oxidation state of less than 3. The method of making the RWGS catalyst results in reduction of iron during deposition of the iron oxide onto the surfaces of the solid catalyst support to produce the reduced iron oxides having iron with the oxidation state of less than 3 attached to the surfaces of the solid catalyst support. Normal wet impregnation techniques do not result in reduction of the iron oxides to deposit iron oxides having iron oxidation states of less than 3 onto the solid catalyst support. In embodiments, the RWGS catalyst may be pressed into tablets, crushed, and then sieved to produce RWGS catalyst particles having an average particle size in a range of from about 200 micrometer (μm) to about 500 μm. The RWGS catalyst may have any of the compositions, properties, or characteristics previously discussed in the present disclosure for the RWGS catalyst.

The RWGS catalyst may be used in the processes for converting CO₂ to CO through the reverse water gas shift reaction. The processes of the present disclosure for converting CO₂ to CO may comprise contacting a carbon dioxide stream with hydrogen in the presence of the RWGS catalyst at a temperature of from 400° C. (673 Kelvin (K)) to 600° C. (873 K), where the RWGS catalyst comprises the reduced iron oxide and the alkali metal promoter deposited on the surface of the catalyst support. The RWGS catalyst may have any of the compositions, properties, or characteristics previously discussed in the present disclosure for the RWGS catalyst. The contacting may cause the CO₂ in the carbon dioxide stream and the hydrogen to undergo a reverse water gas shift reaction to produce carbon monoxide and water.

Referring again to FIG. 1, the process of the present disclosure for converting CO₂ to CO by the RWGS reaction may be conducted in the system 100. The system 100 may include the reactor 110 comprising the RWGS catalyst 112 disposed in the reaction zone 114 of the reactor 110. The system 100 may also include the condenser 120 and the product separation system 130, both of which may be disposed downstream of the reactor 110.

The system 100 may include at least one reactor 110. In embodiments, the reactor 110 may be a fixed bed reactor. In embodiments, the reactor 110 may include a plurality of fixed bed reactors operated in parallel or in series. In embodiments, the reactor 110 may include a plurality of fixed bed reactors operated in swing mode. Operation of the reactor 110 will be described herein in the context of a fixed bed reactor. However, it is understood that other types of reactors, such as fluid bed reactors, batch reactors, FCC reactors, moving bed reactors, or other type of reactor may also be used to contact the carbon dioxide stream with hydrogen in the presence of the RWGS catalyst 112 to conduct the reverse water gas shift reaction of the processes disclosed herein. The RWGS catalyst 112 may be disposed within a reaction zone 114 within the reactor 110. The reactor 110 may include a porous packing material (not shown), such as but not limited to silica carbide packing, upstream and downstream of the reaction zone 114, which may aid in maintaining the RWGS catalyst 112 within the reaction zone 114.

In embodiments, the processes of the present disclosure may include activating the RWGS catalyst 112 prior to conducting the RWGS reaction in the reactor 110. After loading the RWGS catalyst 112 into the reaction zone 114 of the reactor 110, the RWGS catalyst 112 may be activated to further reduce the iron oxide of the catalyst. Activating the RWGS catalyst 112 may include subjecting the RWGS catalyst 112 to a flow of hydrogen at an activation temperature and for an activation time period. The activation temperature may be from 325° C. (˜600 K) to 725° C. (˜1000 K), such as from 325° C. to 650° C., from 325° C. to 550° C., from 400° C. to 725° C., from 400° C. to 650° C., from 400° C. to 550° C., from 450° C. to 725° C., from 450° C., to 650° C., or from 450° C. (723 K) to 550° C. (823 K). The activation time period may be from 1 hour to 5 hours, or from 3 hours to 5 hours. Activation under the flow of hydrogen further reduces the iron oxide of the RWGS catalyst 112.

Referring again to FIG. 1, the carbon dioxide stream 102 may be introduced to the reactor 110. The reactor 110 may be in fluid communication with the carbon dioxide stream 102 to pass the carbon dioxide stream 102 directly to the reactor 110, such as passing the carbon dioxide stream 102 to the reactor 110 without passing the carbon dioxide stream 102 to any separation system or unit operation that changes the overall composition of the carbon dioxide stream 102. In embodiments, introducing the carbon dioxide stream 102 to the reactor 110 may include heating the carbon dioxide stream 102 upstream of the reactor 110. In embodiments, the carbon dioxide stream 102 may be heated to a temperature of from 150° C. to 400° C.

The carbon dioxide stream 102 may be any stream comprising carbon dioxide as a significant component, such as CO₂ present in an amount greater than or equal to 30 wt. %. The carbon dioxide stream 102 may be a gas stream produced from a hydrocarbon refinery, a power plant, heavy industry (such as but not limited to steel production, cement forming, or other heavy industry), or other carbon dioxide source. In embodiments, the carbon dioxide stream 102 may have a concentration of CO₂ of greater than 30 wt. %, greater than or equal to 40 wt. %, greater than or equal to 50 wt. %, greater than or equal to 60 wt. %, greater than or equal to 70 wt. %, greater than or equal to 80 wt. %, greater than or equal to 90 wt. %, or even greater than or equal to 95 wt. % CO₂ based on the total mass flow rate of the carbon dioxide stream 102.

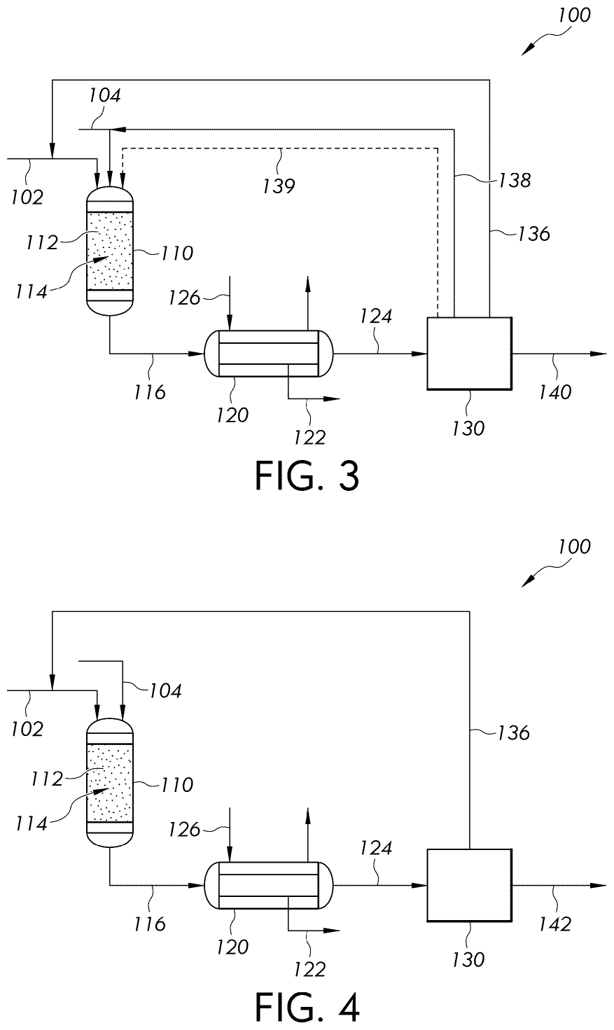

Referring again to FIG. 1, the reactor 110 may be in fluid communication with a hydrogen source (not shown) to pass the hydrogen 104 to the reactor 110. The hydrogen 104 may comprise a hydrogen feed from an external hydrogen source (not depicted), excess hydrogen recovered from the reaction effluent 116, or any combination of both. In embodiments, the hydrogen 104 may be passed separately and independently to the reactor 110 and combined with the carbon dioxide stream 102 within the reactor 110. The hydrogen 104 may comprise primarily hydrogen gas (H₂), such as having greater than or equal to 90 wt. %, greater than or equal to 95 wt. %, greater than or equal to 98 wt. %, greater than or equal to 99 wt. %, or even greater than or equal to 99.9 wt. % hydrogen. In embodiments, at least a portion of the hydrogen 104 may be provided by a recycle stream recovered from the reaction effluent 116 passed out of the reactor 110. In embodiments, the recycle stream may be a hydrogen recycle stream 138 (FIG. 3). In embodiments, the recycle stream may be a combined recycle stream 139 (broken line in FIG. 3) that recycles unreacted carbon dioxide and excess hydrogen back to the reactor 110. Recycle streams passing CO₂, hydrogen, or both recovered from the reaction effluent 116 back to the reactor 110 will be discussed in further detail subsequently in this disclosure.

Referring again to FIG. 1, the reactor 110 may be configured to contact the carbon dioxide stream 102 with the hydrogen 104 in the presence of the RWGS catalyst 112 to produce the reaction effluent 116 comprising at least CO and water. The processes of the present disclosure may include contacting the CO₂ of the carbon dioxide stream 102 with the hydrogen 104 in the presence of the RWGS catalyst 112 in the reactor 110, which comprises a fixed bed reactor. The carbon dioxide stream 102 may be contacted with the hydrogen 104 in the presence of the RWGS catalyst 112 under reaction conditions sufficient to cause at least a portion of the carbon dioxide stream 102 to undergo a RWGS reaction with hydrogen to produce CO and water.

The processes of the present disclosure may include contacting the carbon dioxide stream 102 with the hydrogen 104 in the presence of the RWGS catalyst 112 at a reaction temperature of greater than or equal to 350° C., greater than or equal to 400° C., greater than or equal to 450° C., or even greater than or equal to 500° C. In embodiments, the reaction temperature may be from 350° C. to 600° C., such as from 350° C. to 550° C., from 350° C. to 500° C., from 400° C. to 600° C., from 400° C. to 550° C., from 400° C. to 500° C., from 450° C. to 600° C., from 450° C. to 550° C., from 450° C. to 500° C., or from 500° C. to 600° C. The process of the present disclosure may include contacting the carbon dioxide stream 102 with the hydrogen 104 in the presence of the hydrogen 104 at a pressure of from 80 kilopascals (kPa) to 120 kPa, from 80 kPa to 110 kPa, from 80 kPa to 105 kPa, from 80 kPa to 102 kPa, from 90 kPa to 110 kPa, from 90 kPa to 105 kPa, from 90 kPa to 102 kPa, or about 101 kPa. In embodiments, processes may include contacting the carbon dioxide stream 102 with the hydrogen 104 in the presence of the hydrogen 104 at atmospheric pressure (˜101.325 kPa as sea level).

In embodiments, processes of the present disclosure may include contacting the carbon dioxide stream 102 with the hydrogen 104 in the presence of the RWGS catalyst 112 at a gas hourly space velocity (GHSV) in the reaction zone 114 of the reactor 110 of from 3300 per hour to 13,200 per hour, such as from 3300 per hour to 12,000 per hour, from 3300 per hour to 10,000 per hour, from 3300 per hour to 8000 per hour, from 3300 per hour to 5000 per hour, from 4000 per hour to 13,200 per hour, from 4000 per hour to 12,000 per hour, from 4000 per hour to 10,000 per hour, from 4000 per hour to 8000 per hour, from 4000 per hour to 5000 per hour, from 5000 per hour to 13,200 per hour, from 5000 per hour to 12,000 per hour, from 5000 per hour to 10,000 per hour, from 5000 per hour to 8000 per hour, from 8000 per hour to 13,200 per hour, from 8000 per hour to 12,000 per hour, from 8000 per hour to 10,000 per hour, from 10,000 per hour to 13,200 per hour, or from 10,000 per hour to 12,000 per hour. In embodiments, processes of the present disclosure may include contacting the carbon dioxide stream 102 with the hydrogen 104 in the presence of the RWGS catalyst 112 at a molar ratio of the H₂ to CO₂ introduced to the reactor 110 of from 1 to 6, or from 1 to 5. The molar ratio of the H₂ to CO₂ introduced to the reactor 110 is the total molar flow rate of H₂ introduced to the reactor 110 divided by the total molar flow rate of CO₂ to the reactor 110. The molar flow rate of the H₂ in the reactor 110 is the sum of the products of the total flow rate times the H₂ concentration for each of the streams containing H₂, as shown below in Equation 2 (EQU. 2).

$${F}_{H} = {\sum }_{1}^{i} {F}_{i} \times {[ {H}_{2} ]}_{i} \qquad EQU . 2$$

In EQU. 2, FH is the flow rate of H₂ in the reactor 110, Fᵢ is the total flow rate of stream i, and [H₂]ᵢ is the concentration of H₂ in stream i. Likewise, the molar flow rate of the CO₂ in the reactor 110 is the sum of the products of the total flow rate times the CO₂ concentration for each of the streams containing CO₂, as shown below in Equation 3 (EQU. 3).

$${F}_{C O 2} = {\sum }_{1}^{i} {F}_{i} \times {[ {CO}_{2} ]}_{i} \qquad EQU . 3$$

In EQU. 2, F_{CO2} is the flow rate of CO₂ in the reactor 110, Fᵢ is the total flow rate of stream i, and [CO₂]ᵢ is the concentration of CO₂ in stream i.

Referring again to FIG. 1, the reaction effluent 116 may be passed out of the reactor 110. The reaction effluent 116 may include CO and water produced from the RWGS reaction in the reactor 110. The reaction effluent 116 may also include unreacted CO₂ and excess unreacted H₂. The reaction effluent 116 may also include any non-reactive gases from the carbon dioxide stream 102 passing through the reactor 102. The non-reactive gases refer to gases that do not undergo any reaction in the reactor 110 when contacted with hydrogen in the presence of the RWGS catalyst 112 at the reaction conditions. The reaction effluent 116 may also include any side reaction products produced from side reactions occurring in the reactor 110. In embodiments, the reaction effluent 116 may include CO, water, unreacted CO₂, and unreacted H₂.

As previously discussed, the processes of the present disclosure for converting CO₂ to CO using the RWGS catalyst may have a high selectivity for CO over other side reaction products, such as but not limited to methane. In embodiments, the processes of the present disclosure may have a selectivity for CO of greater than or equal to 90%, greater than or equal to 95%, greater than or equal to 98%, greater than or equal to 99%, or even greater than or equal to 99.9% at reaction temperatures of from 400° C. to 600° C., atmospheric pressure, and a molar ratio of H₂ to CO₂ introduced to the reactor 110 of greater than or equal to 1. In embodiments, the processes may have a selectivity for CO of from 90% to 100%, from 90% to 99.9%, from 90% to 99%, from 90% to 95%, from 95% to 100%, from 95% to 99.9%, from 95% to 99%, from 98% to 100%, from 98% to 99.9%, from 98% to 99%, or even from 99% to 100% at the reaction temperatures of from 400° C. to 600° C., atmospheric pressure, and a molar ratio of H₂ to CO₂ introduced to the reactor 110 of greater than or equal to 1. In embodiments, the process may have a selectivity for CO of 100% at the reaction temperature of from 400° C. to 600° C., atmospheric pressure, and a molar ratio of H₂ to CO₂ introduced to the reactor 110 of greater than or equal to 1.

The processes of the present disclosure for converting CO₂ to CO using the RWGS catalyst may also result in a high conversion of carbon dioxide. In embodiments, the processes of the present disclosure may achieve a conversion of CO₂ of greater than or equal to 5 wt. %, greater than or equal to 10 wt. %, greater than or equal to 20 wt. %, greater than or equal to 30 wt. %, greater than or equal to 35 wt. %, greater than or equal to 40 wt. %, greater than or equal to 45 wt. %, greater than or equal to 50 wt. %, or even greater than or equal to 55 wt. % at reaction temperatures of from 400° C. to 600° C., atmospheric pressure, and a molar ratio of H₂ to CO₂ introduced to the reactor 110 of greater than or equal to 1. In embodiments, the processes of the present disclosure may achieve a conversion of CO₂ of from 5 wt. % to 100 wt. %, from 5 wt. % to 80 wt. %, from 5 wt. % to 70 wt. %, from 5 wt. % to 60 wt. %, from 10 wt. % to 100 wt. %, from 10 wt. % to 80 wt. %, from 10 wt. % to 70 wt. %, from 10 wt. % to 60 wt. %, from 20 wt. % to 100 wt. %, from 20 wt. % to 80 wt. %, from 20 wt. % to 70 wt. %, from 20 wt. % to 60 wt. %, from 30 wt. % to 100 wt. %, from 30 wt. % to 80 wt. %, from 30 wt. % to 70 wt. %, from 30 wt. % to 60 wt. %, from 35 wt. % to 100 wt. %, from 35 wt. % to 80 wt. %, from 35 wt. % to 70 wt. %, from 35 wt. % to 60 wt. %, from 40 wt. % to 100 wt. %, from 40 wt. % to 80 wt. %, from 40 wt. % to 70 wt. %, from 40 wt. % to 60 wt. %, from 45 wt. % to 100 wt. %, from 45 wt. % to 80 wt. %, from 45 wt. % to 70 wt. %, from 45 wt. % to 60 wt. %, from 50 wt. % to 100 wt. %, from 50 wt. % to 80 wt. %, from 50 wt. % to 70 wt. %, from 50 wt. % to 60 wt. %, from 55 wt. % to 100 wt. %, from 55 wt. % to 80 wt. %, from 55 wt. % to 70 wt. %, or from 55 wt. % to 60 wt. %, at reaction temperatures of from 400° C. to 600° C., atmospheric pressure, and a molar ratio of H₂ to CO₂ introduced to the reactor 110 of greater than or equal to 1.

In embodiments, the RWGS catalyst 112 may exhibit good stability in performance over 48 hours of operation at reaction temperatures of from 400° C. to 600° C., atmospheric pressure, and a molar ratio of H₂ to CO₂ introduced to the reactor 110 of greater than or equal to 1. In particular, the RWGS catalyst 112 may provide consistent CO₂ conversion and CO selectivity for a time on stream of greater than or equal to 48 hours when conducting the RWGS reaction at reaction temperatures of from 400° C. to 600° C., atmospheric pressure, and a molar ratio of H₂ to CO₂ introduced to the reactor of from 1 to 6. In embodiments, when conducting the RWGS reaction with the RWGS catalyst at reaction temperatures of from 400° C. to 600° C., atmospheric pressure, and a molar ratio of H₂ to CO₂ introduced to the reactor of from 1 to 6, the CO₂ conversion and CO selectivity may vary by less than 10%, or even less than 5% from the average CO₂ conversion and CO selectivity, respectively, over a period of 48 hours of time on stream.

Referring again to FIG. 1, as previously discussed, the reaction effluent 116 may contain CO, water, unreacted CO₂, and excess unreacted H₂. In embodiments, the system 100 may include the condenser 120 disposed downstream of the reactor 110. The condenser 120 may be configured to condense the water from the reaction effluent 116 to produce a water stream 122 and a product stream 124. The condenser 120 may be in fluid communication with an outlet of the reactor 110 to pass the reaction effluent 116 from the reactor 110 to the condenser 120. In embodiments, the reaction effluent 116 may be passed directly from the reactor 110 to the condenser 120 without passing through any intervening unit operations that change the composition of the reaction effluent 116. The condenser 120 may be operated at a temperature less than the temperature of the reaction effluent 116 at the outlet of the reactor 110 and at a temperature suitable for condensing water from the reaction effluent 116 at the operating pressure of the condenser. The temperature of the condenser 120 may be maintained by passing a cooling fluid 126 through the condenser 120 to remove heat from the reaction effluent 116. The removal of heat and reduction in temperature of the reaction effluent 116 may cause the water vapor in the reaction effluent 116 to condense from the gas phase to the liquid phase. In embodiments, the condenser 120 may be operated at a temperature of from 0 (zero) ° C. to 10° C. at a condenser pressure of around atmospheric pressure (80 kilopascals (kPa) to 120 kPa, from 80 kPa to 110 kPa, from 80 kPa to 105 kPa, from 80 kPa to 102 kPa, from 90 kPa to 110 kPa, from 90 kPa to 105 kPa, from 90 kPa to 102 kPa, or about 101 kPa). In embodiments, the condenser 120 may be operated at a temperature of 0° C. (273 K) at atmospheric pressure (about 101 kPa).

The processes of the present disclosure may include removing water from the reaction effluent 116 to produce the water stream 122 and the product stream 124, where the product stream 124 comprises carbon monoxide. Removing the water from the reaction effluent 116 may comprise passing the reaction effluent 116 to the condenser 120 configured to condense the water from the reaction effluent 116 to produce the water stream 122 and the product stream 124.

The product stream 124 may include CO, unreacted CO₂, and unreacted H₂. The product stream 124 may include greater than or equal to 90 wt. %, greater than or equal to 95 wt. %, greater than or equal to 98 wt. %, greater than or equal to 99 wt. %, or greater than or equal to 99.9 wt. % of the CO from the reaction effluent 116. The product stream 124 may include greater than or equal to 90 wt. %, greater than or equal to 95 wt. %, greater than or equal to 98 wt. %, greater than or equal to 99 wt. %, or greater than or equal to 99.9 wt. % of the unreacted CO₂ from the reaction effluent 116. The product stream 124 may include greater than or equal to 90 wt. %, greater than or equal to 95 wt. %, greater than or equal to 98 wt. %, greater than or equal to 99 wt. %, or greater than or equal to 99.9 wt. % of the unreacted H₂ from the reaction effluent 116. In embodiments, the product stream 124 may include other gases, such as but not limited to non-reactive gases from the CO₂ stream passing through the reactor 110 and condenser 120, side reaction products such as but not limited to methane, trace water not separated out in the condenser 120, or other gases.

Referring again to FIG. 1, the system 100 may include the product separation system 130 disposed downstream of the reactor 110 and the condenser 120. In embodiments, the product separation system 130 may be in fluid communication with the condenser 120 to pass the product stream 124 directly from the condenser 120 to the product separation system 130. The product separation system 130 may be operable to separate the product stream 124 into a CO-containing stream 132 and at least one recycle stream 134. The product separation system 150 may include one or a plurality of separation units. In embodiments, the separation units may include but are not limited to pressure swing adsorption units, cryogenic distillation units, or combinations of these.

The processes disclosed herein may include passing the product stream 124 to the product separation system 130 and separating the product stream 124 in the product separation system 130 to produce the CO-containing stream 132 and at least one recycle stream 134. The CO-containing stream 132 may include the CO from the product stream 124, such as greater than or equal to 90 wt. %, greater than or equal to 95 wt. %, greater than or equal to 98 wt. %, greater than or equal to 99 wt. %, or even greater than or equal to 99.9 wt. % of the CO from the product stream 124. In embodiments, the CO-containing stream 132 may include at least a portion of or all of the unreacted H₂ from the product stream 124. The CO-containing stream 132 may include less than 10 wt. %, less than 5 wt. %, less than 2 wt. %, less than 1 wt. %, or even less than 0.1 wt. % of the unreacted CO₂ from the product stream 124. The CO-containing stream 132 may be passed to one or more downstream unit operations, such as to a downstream Fischer-Tropsche reaction system or alcohol synthesis system in which the CO from the CO containing stream 132 may be converted to hydrocarbons through a Fischer-Tropsche reaction or to alcohols through various alcohol synthesis reactions.

The at least one recycle stream 134 may include the unreacted CO₂ from the product stream 124. In embodiments, the at least one recycle stream 134 may include greater than or equal to 90 wt. %, greater than or equal to 95 wt. %, greater than or equal to 98 wt. %, greater than or equal to 99 wt. %, or even greater than or equal to 99.9 wt. % of the unreacted CO₂ from the product stream 124. In embodiments, the at least one recycle stream 134 may include at least a portion of or all of the unreacted H₂ from the product stream 124. The at least one recycle stream 134 may be passed back to the reactor 110 as at least a portion of the CO₂ introduced to the reactor 110, and optionally at least a portion of the H₂ introduced to the reactor 110. The at least one recycle stream 134 may be combined with the CO₂ stream 102, the hydrogen 104, or both upstream of the reactor 110 or may be passed separately and independently to the reactor 110 and combined with the CO₂ stream 102 and the hydrogen 104 inside the reactor 110.

Referring now to FIG. 3, in embodiments, the product separation system 130 may be operable to produce a CO stream 140, a CO₂ recycle stream 136, and an H₂ recycle stream 138. The CO stream 140 may include the CO from the product stream 124, such as greater than or equal to 90 wt. %, greater than or equal to 95 wt. %, greater than or equal to 98 wt. %, greater than or equal to 99 wt. %, or even greater than or equal to 99.9 wt. % of the CO from the product stream 124. The CO stream 140 may include very little of the unreacted CO₂ and H₂ from the product stream 124. In embodiments, the CO stream 140 may include less than 10 wt. %, less than 5 wt. %, less than 2 wt. %, less than 1 wt. %, or even less than 0.1 wt. % of the unreacted CO₂ from the product stream 124. In embodiments, the CO stream 140 may include less than 10 wt. %, less than 5 wt. %, less than 2 wt. %, less than 1 wt. %, or even less than 0.1 wt. % of the unreacted H₂ from the product stream 124. In embodiments, the CO stream 140 may include greater than or equal to 80 wt. %, greater than or equal to 90 wt. %, greater than or equal to 95 wt. %, greater than or equal to 98 wt. %, or greater than or equal to 99 wt. % CO based on the total weight of the CO stream 140. The CO stream 140 may be passed on to one or more downstream unit operations (not shown) for further processing of the CO or conversion of the CO to hydrocarbons or alcohols, such as through a Fischer-Tropsche reaction, alcohol synthesis system, or other conversion reaction scheme.

The CO₂ recycle stream 136 may include the unreacted CO₂ from the product stream 124 and none or very little of the CO and H₂ from the product stream 124. The CO₂ recycle stream 136 may include greater than or equal to 90 wt. %, greater than or equal to 95 wt. %, greater than or equal to 98 wt. %, greater than or equal to 99 wt. %, or even greater than or equal to 99.9 wt. % of the unreacted CO₂ from the product stream 124. The CO₂ recycle stream 136 may include less than 10 wt. %, less than 5 wt. %, less than 2 wt. %, less than 1 wt. %, or even less than 0.1 wt. % of the CO from the product stream 124. The CO₂ recycle stream 136 may include less than 10 wt. %, less than 5 wt. %, less than 2 wt. %, less than 1 wt. %, or even less than 0.1 wt. % of the unreacted H₂ from the product stream 124. In embodiments, the CO₂ recycle stream 136 may include greater than or equal to 80 wt. %, greater than or equal to 90 wt. %, greater than or equal to 95 wt. %, greater than or equal to 98 wt. %, or greater than or equal to 99 wt. % unreacted CO₂ based on the total weight of the CO₂ recycle stream 136.

Referring again to FIG. 3, the processes of the present disclosure may include separating the product stream 124 to produce the CO₂ recycle stream 136 and passing the CO₂ recycle stream 136 back to the reactor 110. Passing the CO₂ recycle stream 136 back to the reactor 110 may include combining the CO₂ recycle stream 136 with the CO₂ stream 102 upstream of the reactor 110 or passing the CO₂ recycle stream 136 directly to the reactor 110 separate from and independent of the CO₂ stream 102. The system 100 may include a CO₂ recycle line fluidly coupling the product separation system 130 to the reactor 110 to pass the CO₂ recycle stream 136 back to the reactor 110. Recycling the unreacted CO₂ back to the reactor 110 may increase the overall conversion of CO₂ achieved by the process. In embodiments, the CO₂ recycle stream 136 may include a bleed stream (not shown), which may help to avoid buildup of inert gases and contaminants in the system 100.

The H₂ recycle stream 138 may include the unreacted H₂ from the product stream 124 and none or very little of the CO and unreacted CO₂ from the product stream 124. The H₂ recycle stream 138 may include greater than or equal to 90 wt. %, greater than or equal to 95 wt. %, greater than or equal to 98 wt. %, greater than or equal to 99 wt. %, or even greater than or equal to 99.9 wt. % of the unreacted H₂ from the product stream 124. The H₂ recycle stream 138 may include less than 10 wt. %, less than 5 wt. %, less than 2 wt. %, less than 1 wt. %, or even less than 0.1 wt. % of the CO from the product stream 124. The H₂ recycle stream 138 may include less than 10 wt. %, less than 5 wt. %, less than 2 wt. %, less than 1 wt. %, or even less than 0.1 wt. % of the unreacted CO₂ from the product stream 124. In embodiments, the H₂ recycle stream 138 may include greater than or equal to 80 wt. %, greater than or equal to 90 wt. %, greater than or equal to 95 wt. %, greater than or equal to 98 wt. %, or greater than or equal to 99 wt. % H₂ based on the total weight of the H₂ recycle stream 138.

Referring again to FIG. 3, the processes of the present disclosure may include separating the product stream 124 to produce the H₂ recycle stream 138 and passing the H₂ recycle stream 138 back to the reactor 110. Passing the H₂ recycle stream 138 back to the reactor 110 may include combining the H₂ recycle stream 138 with the hydrogen 104 upstream of the reactor 110 or passing the H₂ recycle stream 138 directly to the reactor 110 separate from and independent of the hydrogen 104. The system 100 may include an H₂ recycle line fluidly coupling the product separation system 130 to the reactor 110 to pass the H₂ recycle stream 138 back to the reactor 110. Recycling the unreacted H₂ back to the reactor 110 may reduce the raw material costs of the process by reusing unreacted hydrogen back in the process. In embodiments, the H₂ recycle stream 138 may include a bleed stream (not shown), which may help to avoid buildup of inert gases and contaminants in the system 100.

In embodiments, the unreacted CO₂ and the unreacted H₂ separated from the product stream 124 in the product separation system 130 may be recycled back to the reactor 110 in a combined recycle stream 139, which is depicted in FIG. 3 using a broken line. In embodiments, the system 100 may include a single recycle line and the unreacted CO₂ and the unreacted H₂ may combined to form the combined recycle stream 139 and then passed back to the reactor 110 through the single recycle line. The combined recycle stream 139 may be combined with the CO₂ stream 102, the hydrogen 104, or both upstream of the reactor 110, or may be passed separately and independently to the reactor 110. The combined recycle stream 139 may include greater than or equal to 90 wt. %, greater than or equal to 95 wt. %, greater than or equal to 98 wt. %, greater than or equal to 99 wt. %, or even greater than or equal to 99.9 wt. % of the unreacted CO₂ from the product stream 124. The combined recycle stream 139 may include greater than or equal to 90 wt. %, greater than or equal to 95 wt. %, greater than or equal to 98 wt. %, greater than or equal to 99 wt. %, or even greater than or equal to 99.9 wt. % of the unreacted H₂ from the product stream 124. The combined recycle stream 139 may include less than 10 wt. %, less than 5 wt. %, less than 2 wt. %, less than 1 wt. %, or even less than 0.1 wt. % of the CO from the product stream 124.

Referring now to FIG. 4, in embodiments, the product separation system 130 may be operable to separate the unreacted CO₂ from the product stream 124 to produce the CO₂ recycle stream 136 and a syngas stream 142, where the syngas stream 142 includes the CO produced from the RWGS reaction and the excess unreacted H₂. The CO₂ recycle stream 136 may have any of the compositions and properties previously discussed for the CO₂ recycle stream 136. As previously discussed, the CO₂ recycle stream 136 may be passed from the product separation system 130 back to the reactor 110.

The syngas stream 142 may include greater than or equal to 90 wt. %, greater than or equal to 95 wt. %, greater than or equal to 98 wt. %, greater than or equal to 99 wt. %, or even greater than or equal to 99.9 wt. % of the CO from the product stream 124. The syngas stream may include greater than or equal to 90 wt. %, greater than or equal to 95 wt. %, greater than or equal to 98 wt. %, greater than or equal to 99 wt. %, or even greater than or equal to 99.9 wt. % of the unreacted H₂ from the product stream 124. The combined recycle stream 139 may include less than 10 wt. %, less than 5 wt. %, less than 2 wt. %, less than 1 wt. %, or even less than 0.1 wt. % of the unreacted CO₂ from the product stream 124. The syngas stream 142 may be passed downstream to a reaction system (not shown) for converting the CO and H₂ to hydrocarbons through a Fischer-Tropsche reaction process, an alcohol synthesis process, or other process.

### EXAMPLES

The various aspects of the present disclosure will be further clarified by the following examples. The examples are illustrative in nature and should not be understood to limit the subject matter of the present disclosure.

### Example 1—Synthesis of Sodium-Titanate Support

In Example 1, a catalyst support comprising sodium titanate (NaHTiO₃) was synthesized for use in preparing the RWGS catalysts of the examples. The sodium titanate catalyst support of Example 1, is abbreviated as NaTiNT in these Examples. First 8.80 grams (g) of titania (TiO₂) was dispersed in 47.52 g of de-ionized water. The TiO2 was anatase titania obtained from Thermo Scientific. The titania mixture was stirred at room temperature (˜20° C.) for 30 minutes. Next, 84.48 milliliters (mL) of 12.5 molar (M) sodium hydroxide solution was added dropwise to the titania solution under vigorous stirring to produce a titania mixture having an NaOH concentration to 8 M. The titania mixture was further homogenized by stirring at room temperature (˜20° C.) for 2 hours. The titania mixture was then transferred to a Teflon-lined stainless-steel autoclave and heated at 140° C. (˜413 K) for 60 hours under continuous agitation provided via the mechanical tumbling of the autoclave. The autoclave was then cooled to ambient temperature (˜20° C.) and the solid product was separated from the mother-liquor by filtration using conventional filter paper. This solid was then washed with 100 mL of de-ionized water at least three times, filtered, and re-dispersed in 100 mL de-ionized water. The pH of this dispersion was then reduced from about 12.7 to 5.0 by dropwise addition of 0.2 molar nitric acid (HNO₃) solution. This sodium titanate was then filtered from the water and dried at a temperature of 100° C. (373 K). The resulting sodium content of the sodium titanate was found to be from 1.5 wt. % to 20 wt. %. The sodium titanate was found to have a specific surface area of from 300 m²/g to 350 m²/g. The specific surface area was determined according to the BET method.

The sodium titanate of Example 1 was analyzed using X-Ray Diffraction (XRD) spectroscopy. The XRD pattern of the synthesized sodium titanate was obtained using a Rigaku MiniFlex-600 X-ray Diffractometer with copper (Cu) Kα (λ=0.154059 nm) radiation, fixed slit incidence (0.25° divergence, 0.5° anti-scatter, specimen length of 10 mm), and diffracted optics (0.25° anti-scatter, 0.02 mm nickel filter). The XRD data was obtained at 40 kilovolts (kV) and 15 milliampere (mA) over a 2θ range of from 5° to 75° using a Pixcel detector with a PSD length of 3.350 (2θ), and 255 active channels.

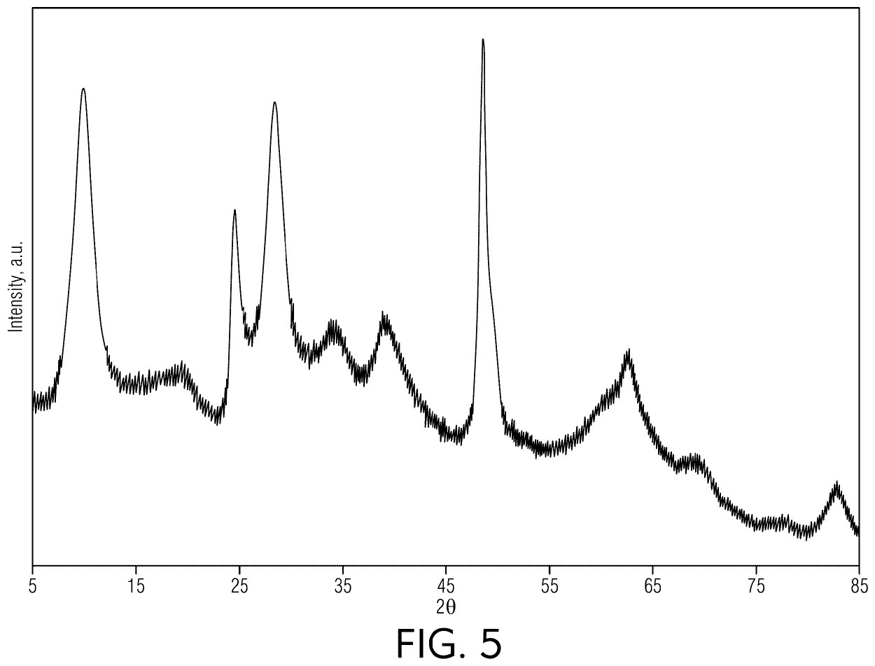

The formation of titanate nanotubes was verified by the emergence of a broad low angle reflection between 7.2° and 10.3° 2θ in the XRD pattern, as shown in FIG. 5, corresponding to reflection from the (200) plane, which is characteristic of titanate nanotubes. This peak is attributed to the interlayer spacing (d-spacing) of the layered titanate phase and was calculated using the Bragg's equation to be ˜0.88 nanometer. The major diffraction reflections at about 20=9.76°, 19.45°, 24.04°, 27.82°, 29.64°, 33.36°, 39.03°, 43.32°, 46.36°, 48.02°, 49.18°, 55.15°, 56.44°, 61.94°, 62.82°, 63.64° and 69.11° are observed for the sample, which correspond to the (200), (400), (110), (310), (600), (301), (501), (411), (701), (020), (220), (901), (811), (002), (202), (521) and (721) planes of H₂Ti₂O₅·H₂O/NaₓH₂₋ₓTi₂O₅·H₂O crystalline phase (JCPDS No. 47-0124).

### Example 2—Synthesis of Fe-K/NaTiNT-1 Catalyst

In Example 2, an RWGS catalyst comprising iron (Fe) and potassium (K) supported on the sodium titanate catalyst support of Example 1 was produced. First, 0.476 grams (g) of iron sulfate pentahydrate (iron precursor; Fe₂(SO₄)₃·5H₂O, obtained from Thermo Scientific Chemicals) was dissolved in 25 mL of ethylene glycol (obtained from Sigma-Aldrich) with stirring at 85° C. (358 K) for 30 minutes to produce an iron-containing solution. Then, 2.00 g of the sodium titanate of Example 1 was added to the iron-containing solution as the solid catalyst support and vigorously stirred at 85° C. (358 K) for a time of 2 hours to produce a dispersion. The dispersion was then allowed to cool down to room temperature (˜20° C.) before adding 10.0 mL of 0.525 molar hydrazine monohydrate (N₂H₄·H₂O, obtained from Sigma-Aldrich) dissolved in ethylene glycol. The hydrazine monohydrate served as the reducing agent. The dispersion was stirred at room temperature (˜20° C.) for 5 minutes before adding 1.0 g of solid potassium hydroxide (alkali metal precursor) without stirring. The dispersion was then transferred to a Teflon-lined stainless-steel autoclave and heated at 165° C. (438 K) for 48 hours with continuous agitation provided by mechanically tumbling the autoclave. At the end of the heating period, the autoclave was cooled to ambient temperature (˜20° C.) and the solid catalyst product was separated from the mother-liquor of the reaction mixture using conventional filtration. The solid catalyst product was then washed at least three times with ethanol, filtered to dryness at room temperature (˜20° C.), and dried in a vacuum oven at 85° C. (358 K) for from 24 hours to 48 hours to produce the RWGS catalyst of Example 2. The metal content of the RWGS catalyst of Example 2 was measured by X-Ray Fluorescence (XRF) to be 1.9 wt. % sodium (Na), 13.7 wt. % potassium (K), and 4.0 wt. % iron (Fe).

### Example 3—Synthesis of Fe-K/NaTiNT-2 Catalyst

In Example 3, an RWGS catalyst comprising iron (Fe) and potassium (K) supported on the sodium titanate catalyst support of Example 1 was produced. The RWGS catalyst of Example 3 was made by the same method of the RWGS catalyst of Example 2 except that in the initial step, the amount of iron sulfate pentahydrate was increased to 0.733 g in making the iron-containing solution. The metal content of the RWGS catalyst of Example 3 was measured by X-Ray Fluorescence (XRF) to be 2.4 wt. % sodium (Na), 16.4 wt. % potassium (K), and 6.2 wt. % iron (Fe).

### Example 4—Synthesis of Fe-K/NaTiNT-3 Catalyst

In Example 4, an RWGS catalyst comprising iron (Fe) and potassium (K) supported on the sodium titanate catalyst support of Example 1 was produced. The RWGS catalyst of Example 4 was made by the same method of the RWGS catalyst of Example 2 except that, in the initial step, the amount of iron sulfate pentahydrate was increased to 1.005 g in making the iron-containing solution. The metal content of the RWGS catalyst of Example 4 was measured by X-Ray Fluorescence (XRF) F to be 1.6 wt. % sodium (Na), 19.3 wt. % potassium (K), and 11.6 wt. % iron (Fe).

### Example 5—Synthesis of Fe-K/MCM48 Catalyst

In Example 5, an RWGS catalyst comprising iron (Fe) and potassium (K) supported on a silica (SiO₂) catalyst support was produced. First, 0.733 g of the iron sulfate pentahydrate (iron precursor; Fe₂(SO₄)₃·5H₂O, ACROS Organics) was dissolved in 25 mL ethylene glycol under stirring at 85° C. for 30 minutes to produce an iron-containing solution. To the iron-containing solution, 2.00 g of silica fine powder was added as the solid catalyst support and vigorously stirred at 85° C. for 2 hours to produce a dispersion. The silica was MCM48 fine powder silica obtained from Sigma-Aldrich. The dispersion was then allowed to cool down to room temperature (˜20° C.) before adding 10.0 mL of 0.525 molar hydrazine monohydrate (N₂H₄·H₂O, obtained from Sigma-Aldrich) dissolved in ethylene glycol. The hydrazine monohydrate served as the reducing agent. The dispersion was stirred at room temperature (˜20° C.) for 5 minutes before adding 1.0 gram of solid potassium hydroxide (alkali metal precursor) without stirring. The dispersion was next transferred to a Teflon-lined stainless-steel autoclave and heated at 165° C. for 48 hours with continuous agitation provided by mechanically tumbling the autoclave. At the end of the heating period, the autoclave was cooled to ambient temperature (˜20° C.) and the solid catalyst product was separated from the mother-liquor of the reaction mixture using conventional filtration. The solid catalyst product was then washed at least three times with ethanol, filtered to dryness at room temperature, and dried in a vacuum oven at 85° C. for 24 hours to 48 hours to produce the RWGS catalyst of Example 5. The metal content of the RWGS catalyst of Example 5 was measured by X-Ray Fluorescence (XRF) to be 14.4 wt. % potassium (K) and 5.5 wt. % iron (Fe).

### Example 6—Synthesis of Fe-K/Al₂O₃ Catalyst

In Example 6, an RWGS catalyst comprising iron (Fe) and potassium (K) supported on an alumina (Al₂O₃) catalyst support was produced. First, 0.733 g of the iron sulfate pentahydrate (iron precursor; Fe₂(SO₄)₃·5H₂O, ACROS Organics) was dissolved in 25 mL ethylene glycol by stirring at 85° C. for 30 minutes to produce an iron-containing solution. To the iron-containing solution, 2.00 g of gamma-alumina was added as the solid catalyst support and vigorously stirred at 85° C. for 2 hours to produce a dispersion. The gamma-alumina was γ-Al2O3 fine powder obtained from Thermo Fischer Scientific. The dispersion was then allowed to cool down to room temperature (˜20 K) before adding 10.0 mL of 0.525 molar hydrazine monohydrate (N₂H₄·H₂O obtained from Sigma-Aldrich) dissolved in ethylene glycol. The hydrazine monohydrate served as the reducing agent. The dispersion was then stirred at room temperature for 5 minutes before adding 1.0 gram of solid potassium hydroxide (alkali metal precursor) without stirring. The mixture was next transferred to a Teflon-lined stainless-steel autoclave and heated at 165° C. for 48 hours with continuous agitation provided by mechanically tumbling the autoclave. At the end of the heating period, the autoclave was cooled to ambient temperature (˜20° C.) and the solid catalyst product was separated from the mother-liquor of the reaction mixture by conventional filtration. The solid catalyst product was then washed at least three times with ethanol, filtered to dryness at room temperature, and dried in a vacuum oven at 85° C. for 24 hours to 48 hours to produce the RWGS catalyst of Example 6. The metal content of the RWGS catalyst of Example 6 was measured by X-Ray Fluorescence (XRF) to be 14.4 wt. % potassium (K) and 5.4 wt. % iron (Fe).

### Example 7—Synthesis of Fe-K/TiO₂ Catalyst

In Example 7, an RWGS catalyst comprising iron (Fe) and potassium (K) supported on a titania (TiO₂) catalyst support was produced. First, 0.733 g of the iron sulfate pentahydrate (iron precursor; Fe₂(SO₄)₃·5H₂O, ACROS Organics) was dissolved in 25 mL ethylene glycol by stirring at 85° C. for 30 minutes to produce an iron-containing solution. To the iron-containing solution, 2.00 g of titania (TiO₂) fine powder was added as the solid catalyst support and vigorously stirred at 85° C. for 2 hours to produce a dispersion. The titania was the anatase-TiO₂ fine powder obtained from Thermo Fischer Scientific. The dispersion was then allowed to cool down to room temperature (˜20 K) before adding 10.0 mL of 0.525 molar hydrazine monohydrate (N₂H₄·H₂O, obtained from Sigma-Aldrich) dissolved in ethylene glycol. The hydrazine monohydrate served as the reducing agent. The dispersion was stirred at room temperature for 5 minutes before adding 1.0 gram of solid potassium hydroxide (alkali metal precursor) without stirring. The dispersion was transferred to a Teflon-lined stainless-steel autoclave and heated at 165° C. for 48 hours with continuous agitation provided by mechanically tumbling the autoclave. At the end of the heating period, the autoclave was cooled to ambient temperature (˜20° C.) and the solid catalyst product was separated from the mother-liquor of the reaction mixture using conventional filtration. The solid catalyst product was then washed at least three times with ethanol, filtered to dryness at room temperature, and dried in a vacuum oven at 85° C. for 24 hours to 48 hours to produce the RWGS catalyst of Example 7. The metal content of the RWGS catalyst of Example 7 was measured by X-Ray Fluorescence (XRF) to be 14.3 wt. % potassium (K) and 6.5 wt. % iron (Fe).

### Example 8—Synthesis of Fe-K/ZrO₂ Catalyst

In Example 8, an RWGS catalyst comprising iron (Fe) and potassium (K) supported on a zirconia (ZrO₂) catalyst support was produced. First, 0.733 g of the iron sulfate pentahydrate (iron precursor; Fe₂(SO₄)₃·5H₂O, ACROS Organics) was dissolved in 25 mL ethylene glycol by stirring at 85° C. for 30 minutes to produce an iron-containing solution. To the iron-containing solution, 2.00 g of zirconia was added as the solid catalyst support and vigorously stirred at 85° C. for 2 hours to produce a dispersion. The zirconia was ZrO₂ fine powder obtained from Thermo Fisher Scientific. The dispersion was then allowed to cool down to room temperature (˜20 K) before adding 10.0 mL of 0.525 molar hydrazine monohydrate (N₂H₄·H₂O, obtained from Sigma-Aldrich) dissolved in ethylene glycol. The hydrazine monohydrate served as the reducing agent. The dispersion was stirred at room temperature for 5 minutes before adding 1.0 gram of solid potassium hydroxide (alkali metal precursor) without stirring. The dispersion was transferred to a Teflon-lined stainless-steel autoclave and heated at 165° C. for 48 hours with continuous agitation provided by mechanically tumbling the autoclave. At the end of the heating period, the autoclave was cooled to ambient temperature (˜20° C.) and the solid catalyst product was separated from the mother-liquor of the reaction mixture using conventional filtration. The solid catalyst product was then washed at least three times with ethanol, filtered to dryness at room temperature, and dried in a vacuum oven at 85° C. for 24 hours to 48 hours to produce the RWGS catalyst of Example 8. The metal content of the RWGS catalyst of Example 8 was measured by X-Ray Fluorescence (XRF) to be 14.7 wt. % potassium (K) and 6.4 wt. % iron (Fe).

### Example 9—Synthesis of Fe-K/CeO₂ Catalyst

In Example 9, an RWGS catalyst comprising iron (Fe) and potassium (K) supported on a ceria (CeO₂) catalyst support was produced. First, 0.733 g of the iron sulfate pentahydrate (iron precursor; Fe₂(SO₄)₃·5H₂O, ACROS Organics) was dissolved in 25 mL ethylene glycol by stirring at 85° C. for 30 minutes to produce an iron-containing solution. To the iron-containing solution, 2.00 g of ceria fine powder as the solid catalyst support was added and vigorously stirred at 85° C. for 2 hours. The ceria was CeO₂, fine powder obtained from Sigma-Aldrich. The dispersion was then allowed to cool down to room temperature (˜20 K) before adding 10.0 mL of 0.525 molar hydrazine monohydrate (N₂H₄·H₂O, obtained from Sigma-Aldrich) dissolved in ethylene glycol. The hydrazine monohydrate served as the reducing agent. The dispersion was stirred at room temperature for 5 minutes before adding 1.0 gram of solid potassium hydroxide (alkali metal precursor) without stirring. The dispersion was transferred to a Teflon-lined stainless-steel autoclave and heated at 165° C. for 48 hours with continuous agitation provided by mechanically tumbling the autoclave. At the end of the heating period, the autoclave was cooled to ambient temperature (˜20° C.) and the solid catalyst product was separated from the mother-liquor of the reaction mixture using conventional filtration. The solid catalyst product was then washed at least three times with ethanol, filtered to dryness at room temperature, and dried in a vacuum oven at 85° C. for 24 hours to 48 hours to produce the RWGS catalyst of Example 9. The metal content of the RWGS catalyst of Example 9 was measured by X-Ray Fluorescence (XRF) to be 16.7 wt. % potassium (K) and 6.0 wt. % iron (Fe).

### Example 10—Synthesis of Fe-K/MgO Catalyst

In Example 10, an RWGS catalyst comprising iron (Fe) and potassium (K) supported on a magnesia (MgO) catalyst support was produced. First, 0.733 g of the iron sulfate pentahydrate (iron precursor; Fe₂(SO₄)₃·5H₂O, ACROS Organics) was dissolved in 25 mL ethylene glycol by stirring at 85° C. for 30 minutes to produce an iron-containing solution. To the iron-containing solution, 2.00 g of magnesia fine powder was added as the solid catalyst support and vigorously stirred at 85° C. for 2 hours. The magnesia was EMSURE® MgO fine powder available from MilliporeSigma of Burlington, MA. The dispersion was then allowed to cool down to room temperature (˜20 K) before adding 10.0 mL of 0.525 molar hydrazine monohydrate (N₂H₄·H₂O, obtained from Sigma-Aldrich) dissolved in ethylene glycol. The hydrazine monohydrate served as the reducing agent. The dispersion was stirred at room temperature for 5 minutes before adding 1.0 gram of solid potassium hydroxide (alkali metal precursor) without stirring. The dispersion was transferred to a Teflon-lined stainless-steel autoclave and heated at 165° C. for 48 hours with continuous agitation provided by mechanically tumbling the autoclave. At the end of the heating period, the autoclave was cooled to ambient temperature (˜20° C.) and the solid catalyst product was separated from the mother-liquor of the reaction mixture using conventional filtration. The solid catalyst product was then washed at least three times with ethanol, filtered to dryness at room temperature, and dried in a vacuum oven at 85° C. for 24 hours to 48 hours to produce the RWGS catalyst of Example 10. The metal content of the RWGS catalyst of Example 10 was measured by X-Ray Fluorescence (XRF) to be 16.4 wt. % potassium (K) and 5.9 wt. % iron (Fe).

### Example 11—Synthesis of Fe-K/Bentonite Catalyst

In Example 11, an RWGS catalyst comprising iron (Fe) and potassium (K) supported on a bentonite clay (H₂Al₂O₆Si) catalyst support was produced. First, 0.733 g of the iron sulfate pentahydrate (iron precursor; Fe₂(SO₄)₃·5H₂O, ACROS Organics) was dissolved in 25 mL ethylene glycol by stirring at 85° C. for 30 minutes to produce an iron-containing solution. To the iron-containing solution, 2.00 g of Bentonite clay fine powder was added as the solid catalyst support and vigorously stirred at 85° C. for 2 hours. The Bentonite clay was obtained from Sigma-Aldrich. The dispersion was then allowed to cool down to room temperature (˜20 K) before adding 10.0 mL of 0.525 molar hydrazine monohydrate (N₂H₄·H₂O, obtained from Sigma-Aldrich) dissolved in ethylene glycol. The hydrazine monohydrate served as the reducing agent. The dispersion was stirred at room temperature for 5 minutes before adding 1.0 gram of solid potassium hydroxide (alkali metal precursor) without stirring. The dispersion was transferred to a Teflon-lined stainless-steel autoclave and heated at 165° C. for 48 hours with continuous agitation provided by mechanically tumbling the autoclave. At the end of the heating period, the autoclave was cooled to ambient temperature (˜20° C.) and the solid catalyst product was separated from the mother-liquor of the reaction mixture using conventional filtration. The solid catalyst product was then washed at least three times with ethanol, filtered to dryness at room temperature, and dried in a vacuum oven at 85° C. for 24 hours to 48 hours to produce the RWGS catalyst of Example 11. The metal content of the RWGS catalyst of Example 11 was measured by X-Ray Fluorescence (XRF) to be 0.2 wt. % sodium (Na), 16.6 wt. % potassium (K), and 7.4 wt. % iron (Fe).

### Example 12—Catalyst Preparation and Activation

In Example 12, the activation protocol and reduced state of iron in the RWGS catalysts of Examples 3, 4, 5, 8, 10, and 11 were determined. In order to determine the proper activation protocol for the catalysts and ascertain the reduced state of the synthesized supported iron, Hydrogen-Temperature Programmed Reduction (H₂-TPR) analysis according to known methods was conducted on the RWGS catalysts of Examples 3, 4, 5, 8, 10, and 11.

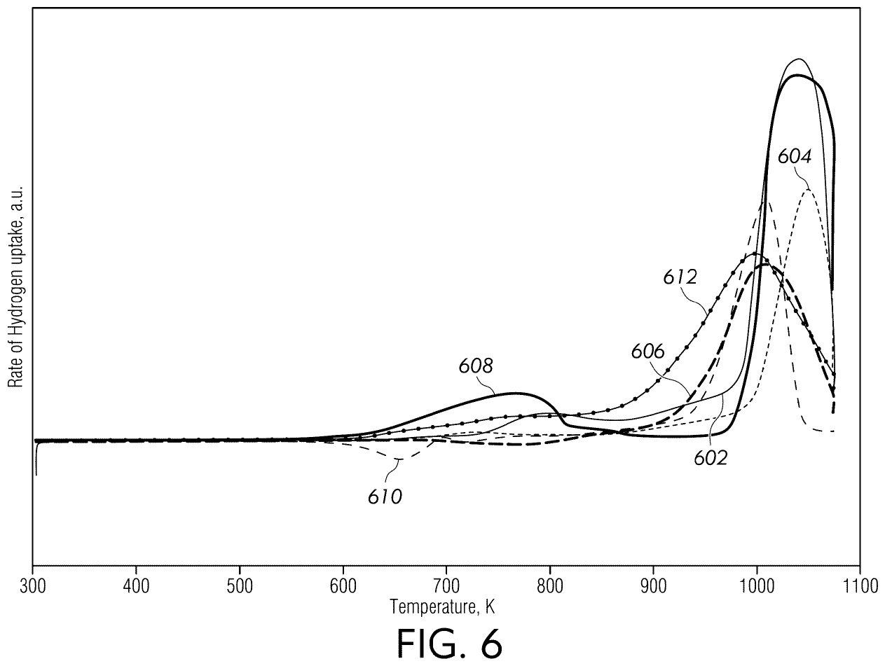

The H₂-TPR profile for each of the samples of the RWGS catalyst of Examples 3, 4, 5, 8, 10, and 11 indicated that a relatively small amount iron ions (Fe³⁺) are reduced in a temperature range of 600 K to 800 K, which account for iron species on the external surface of supported iron particle, while the bulk of the iron is reduced at higher temperatures (900 K to 1100 K), as indicated by the larger peaks on the right side of FIG. 6.

The results of the H₂-TPR analysis for each of the RWGS catalysts of Examples 3, 4, 5, 8, 10, and 11 are provided in FIG. 6, and Table 1 provides correspondence between Examples 3, 4, 5, 8, 10, and 11 and the reference numbers in FIG. 6.

TABLE 1

| | Solid Catalyst | Reference Number in |
|---|---|---|
| Example Catalyst | Support | FIG. 6 |
| 3 | Sodium titanate | 602 |
| 4 | Sodium titanate | 604 |
| 5 | Silica | 606 |
| 8 | Zirconia | 608 |
| 10 | MgO | 610 |
| 11 | Bentonite Clay | 612 |

The RWGS catalysts of Examples 3, 4, 5, 8, 10, and 11 were each pressed to form tablets, crushed, and sieved to form granules having particles size of from 200 micrometers (μm) to 500 μm. An approximate volume of 1.5 cm³ (approx. 0.50 g) of the granules of each catalyst were packed into a tubular Quartz reactor, which was 310 millimeters (mm) in length and 9.1 mm internal diameter. The reactor had a thermocouple immersed into the catalyst bed. Hydrogen at a volume flow rate of about 75 cm³/min was passed over each of the RWGS catalysts and the reactor's temperature was raised to 450° C. (723 K) at the temperature ramp rate of 5° C./min. The temperature of the reactor was maintained at 450° C. for at least 4 hours. The temperature was then changed to the reaction temperature at a rate of 5° C./min.

### Example 13—Catalyst Testing—Effect of Reaction Temperature

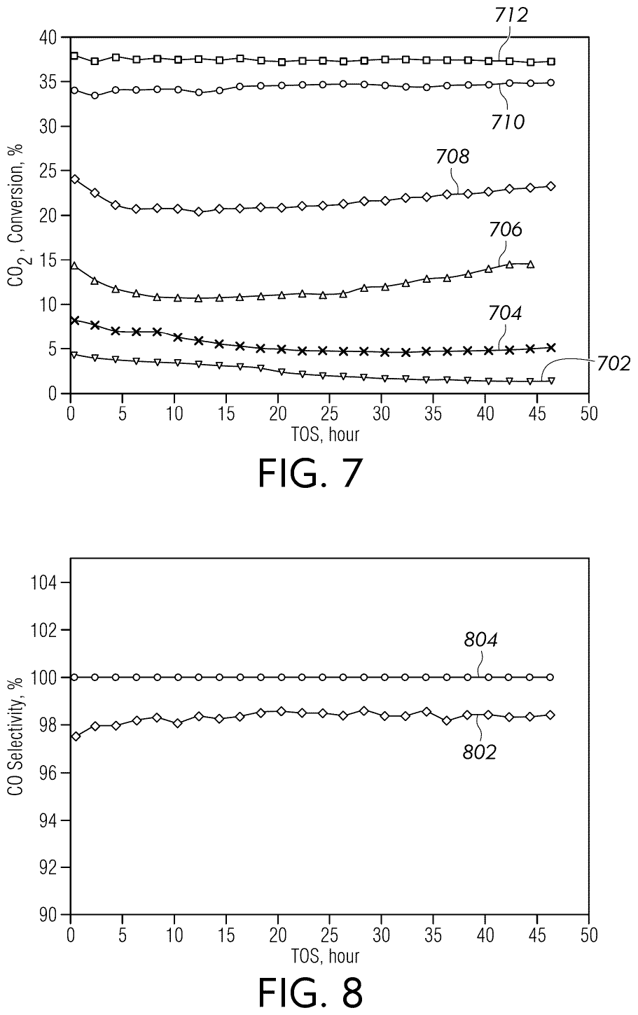

In Example 13, the effects of the reaction temperature on the conversion of CO₂ and selectivity to CO of the RWGS reaction conducted in a continuous flow fixed bed reactor using the RWGS catalyst of Example 4 were evaluated. An amount of 0.5 grams (volume of about 1.5 cm³) of the RWGS catalyst of Example 4, which comprised iron and potassium supported on the sodium titanate of Example 1 as the solid catalyst support, was loaded into the continuous flow fixed bed reactor and activated according to the activation process described in Example 12. After activation, the RWGS reaction was conducted at reaction temperatures of from 350° C. (623 K) to 600° C. (873 K). The RWGS reactions were conducted at atmospheric pressure, a molar ratio of H₂ to CO₂ equal to 1, and a GHSV equal to 3300 mL·(grams of catalyst)⁻¹·hour⁻ⁱ. Referring now to FIG. 7, the CO₂ conversion (y-axis) as a function of time on stream (x-axis) for each temperature is graphically depicted, and Table 2 provides correspondence between the reaction temperatures and the reference numbers in FIG. 7.

TABLE 2

| | | Reference Number in |
|---|---|---|
| Temperature (K) | Temperature (° C.) | FIG. 7 |
| 623 | 350 | 702 |
| 673 | 400 | 704 |
| 723 | 450 | 706 |
| 773 | 500 | 708 |
| 823 | 550 | 710 |
| 873 | 600 | 712 |

As shown in FIG. 7, the CO₂ conversion was greater than 30% at reaction temperatures of 823 K and higher. Concurrent with this relatively high conversion at high temperature is the greater stability of the catalyst, where the CO₂ conversion remained relatively unchanged throughout the duration of the reaction time on stream of 48 hours. Thus, increasing the reaction temperature can increases the CO₂ conversion and catalyst stability. Referring now to FIG. 8, the CO selectivities (y-axis) as a function of time on stream (x-axis) for reaction temperatures of 623 K (ref. no. 802) and 673 K (ref. no. 804) are graphically depicted. As shown in FIG. 8, the selectivity for CO formation over the RWGS catalyst of Example 4 under the same reaction condition reached 100% at reaction temperature of 673 K and higher.

### Example 14—Catalyst Testing—Effect of H₂:CO₂ Molar Ratio

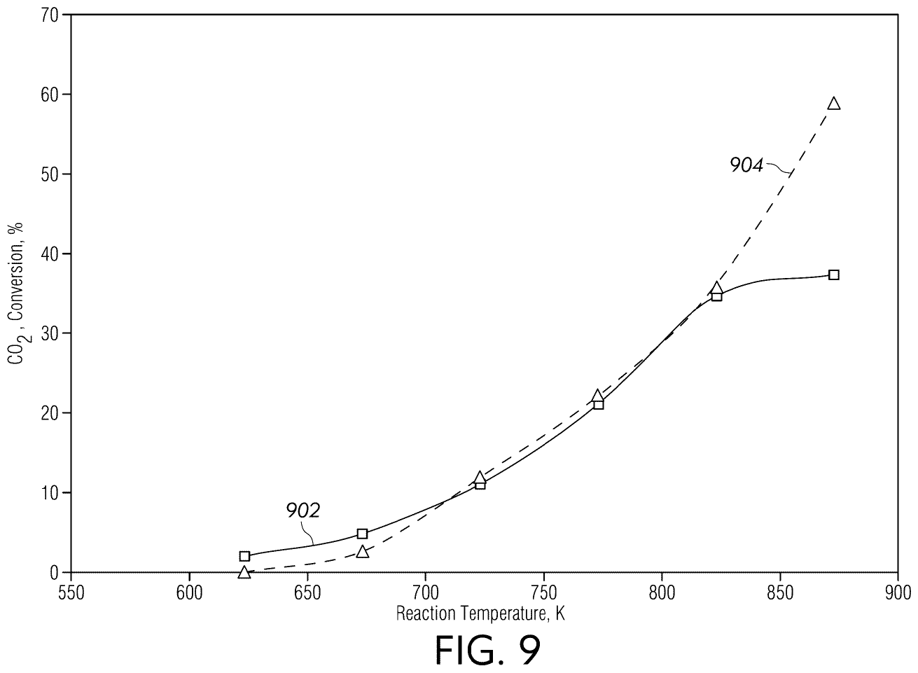

In Example 14, the effects of the molar ratio of the H₂ to CO₂ introduced to the reactor on the CO₂ conversion of the RWGS reaction were evaluated. For Example 14, an amount of 0.5 grams of the RWGS catalyst of Example 4, which comprised iron and potassium supported on sodium titanate of Example 1 as the solid catalyst support, was loaded into the continuous flow fixed bed reactor and activated according to the activation process described in Example 12. After activation, the RWGS reaction was conducted at reaction temperatures of from 350° C. (623 K) to 600° C. (873 K), a pressure of atmospheric pressure, and a GHSV of 3300 mL·(grams of catalyst)⁻¹·hour⁻¹. For Example 14, the RWGS reaction was conducted at a molar ratio of H₂ to CO₂ of 1 (ref. no. 902 in FIG. 9) and a molar ratio of H₂ to CO₂ of 4 (ref. no. 904 in FIG. 9). Referring now to FIG. 9, the CO₂ conversions (y-axis) as a function of reaction temperature (x-axis) for each of the molar ratios of H₂ to CO₂ are graphically depicted. As shown in FIG. 9, the RWGS reaction conducted with the RWGS catalyst of Example 4 is relatively insensitive to the H₂ to CO₂ molar ratio at reaction temperatures of 823 K and lower. However, at a reaction temperature of 873 K, the CO₂ conversion significantly increases when the H₂ to CO₂ molar ratio was 4 (ref. no. 904) and reached 59 wt. % at the reaction temperature of 873 K.

### Examples 15-17—Catalyst Testing—Effect of Iron Content

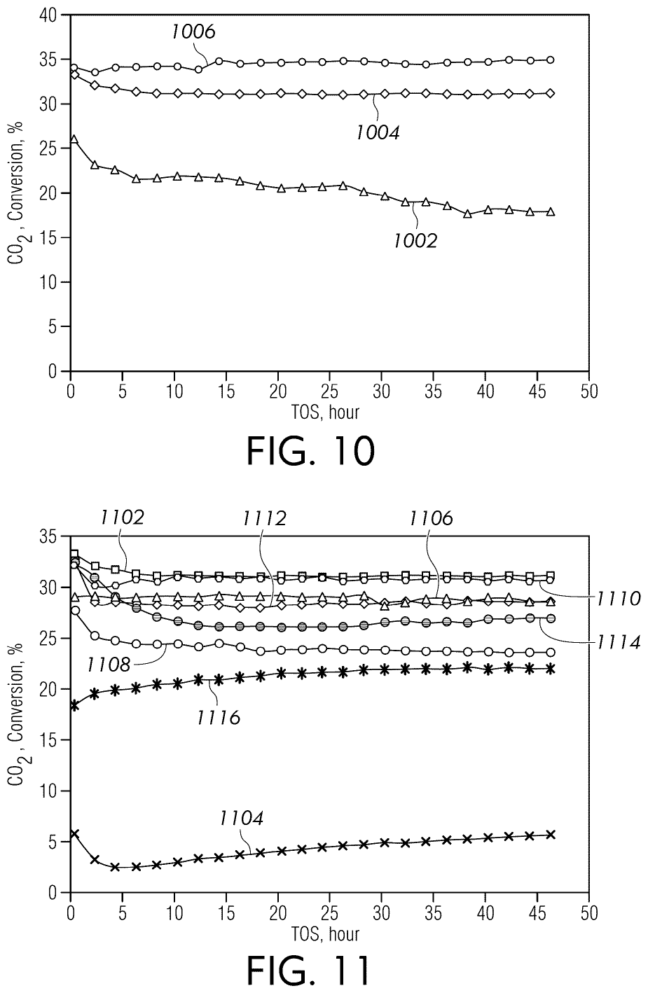

In Examples 15-17, the effects of the iron content in the RWGS catalyst on the RWGS reaction were evaluated. For Examples 15-17, the RWGS catalyst of Examples 2-4 were used to conduct the RWGS reaction in the continuous flow fixed bed reactor system described in Example 12. For each of Examples 15-17, about 0.5 grams of the RWGS catalyst was loaded into the continuous flow fixed bed reactor and activated according to the activation process described in Example 12. After activation, the RWGS reaction was conducted at a reaction temperature of 550° C. (823 K), a pressure of atmospheric pressure, a GHSV of 3300 mL·(grams of catalyst)⁻¹·hour⁻¹, and a molar ratio of H₂ to CO₂ of 1. The results of the CO₂ conversion (y-axis) as a function of time on stream (x-axis) for Examples 15-17 are graphically shown in FIG. 10, and Table 3 provides the reference numbers for Examples 15-17.

TABLE 3

| | | | Reference Number In |
|---|---|---|---|
| Example | Catalyst | Iron Content (wt. %) | FIG. 10 |
| 15 | Example 1 | 4 | 1002 |
| 16 | Example 3 | 6.2 | 1004 |
| 17 | Example 4 | 11.6 | 1006 |

The CO₂ conversion and the catalyst stability increased significantly for Examples 16 and 17, for which the RWGS catalysts had an iron loading greater than 4 wt. %. The CO₂ conversion and catalyst stability increased significantly for Example 16 (iron content of 6.2 wt. %) compared to Example 15 (iron content of 4 wt. %), while the increase in CO₂ conversion and catalyst stability is not as dramatic for Example 17 (iron content of 11.6 wt. %) compared to Example 16 (iron content of 6.2 wt. %), even though the iron content is increased by nearly a factor of 2.

### Examples 16-23—Catalyst Testing—Effect of Solid Catalyst Support

For Examples 16-23, the effects of the different types of solid catalyst support on the CO₂ conversion of the RWGS reaction were evaluated. For Examples 16-23, the RWGS catalysts of Examples 3 and 5-12, which each had an iron content of around 6 wt. %, were used to conduct the RWGS reactions. For each of Examples 16-23, 0.5 grams of the RWGS catalyst was loaded into the continuous flow fixed bed reactor and activated according to the activation process described in Example 12. After activation, the RWGS reaction was conducted at a reaction temperature of 550° C. (823 K), a pressure of atmospheric pressure, a GHSV of 3300 mL·(grams of catalyst)⁻¹·hour⁻¹, and a molar ratio of H₂ to CO₂ of 1. Referring now to FIG. 11, the CO₂ conversion (y-axis) as a function of time on stream (x-axis) is graphically depicted for each of Examples 16-23, and Table 4 provides the catalysts and reference numbers in FIG. 11 for each of Examples 16-23.

TABLE 4

| | | | Reference Number in |
|---|---|---|---|
| Example | Catalyst | Catalyst Support | FIG. 11 |
| 16 | Example 3 | Sodium titanate | 1102 |
| 17 | Example 5 | Silica | 1104 |
| 18 | Example 6 | Alumina | 1106 |
| 19 | Example 7 | Titania (TiO₂) | 1108 |
| 20 | Example 8 | Zirconia (ZrO₂) | 1110 |
| 21 | Example 9 | Ceria (CeO₂) | 1112 |
| 22 | Example 10 | MgO | 1114 |
| 23 | Example 11 | Bentonite clay | 1116 |

As shown in FIG. 11, in terms of CO₂ conversion and catalyst stability, the performance of the RWGS catalyst of Example 3, which was supported on the sodium titanate (NaTiNT), provided superior performance compared to the other RWGS catalysts supported on all other materials. The RWGS catalyst of Example 8, which had the ZrO₂ solid catalyst support (Example 20, ref. no. 1110), was the only RWGS catalyst to provide nearly similar performance to that of Example 16. While the lowest conversion occurred over the silica supported catalyst of Example 17 (ref. no. 1104). Without being bound by any particular theory, it is believed that comparatively weak catalyst support interactions with the silica in the RWGS catalyst of Example 5 may have led to the poor retention and dispersion of the iron (Fe) on the silica support.

A first aspect of the present disclosure is directed to a reverse water gas shift catalyst (RWGS catalyst) for conducting reverse water gas shift reactions to convert carbon dioxide to carbon monoxide, where the RWGS catalyst may comprise reduced iron oxide and an alkali metal promoter supported on a solid catalyst support, where the solid catalyst support comprises a plurality of catalyst support particles and the reduced iron oxide has iron having an oxidation state of less than 3.

A second aspect of the present disclosure may include the first aspect, where the RWGS catalyst may comprise from 4 wt. % to 14 wt. % of the reduced iron oxide based on the total weight of the RWGS catalyst.

A third aspect of the present disclosure may include any one of the first or second aspects, where the reduced iron oxide may comprise Fe₃O₄.

A fourth aspect of the present disclosure may include any one of the first through third aspects, where the alkali metal promoter may comprise an alkali metal selected from the group consisting of lithium (Li), sodium (Na), potassium (K), rubidium (Rb), caesium (Cs), and combinations of these.

A fifth aspect of the present disclosure may include any one of the first through fourth aspects, where the alkali metal promoter may comprise an alkali metal oxide selected from the group consisting of Li₂O, Na₂O, K₂O, Rb₂O, Cs₂O, and combinations thereof.

A sixth aspect of the present disclosure may include any one of the first through fifth aspects, where the RWGS catalyst may comprise from 4 wt. % to 20 wt. % of the alkali metal promoter based on the total weight of the RWGS catalyst.

A seventh aspect of the present disclosure may include any one of the first through sixth aspects, where the alkali metal promoter may comprise potassium.

An eighth aspect of the present disclosure may include any one of the first through seventh aspects, where the solid catalyst support may comprise sodium titanate, potassium titanate, zirconia, alumina, titania, silica, magnesia, ceria, bentonite clay, or combinations thereof.

A ninth aspect of the present disclosure may include any one of the first through eighth aspects, where the solid catalyst support may comprise sodium titanate, potassium titanate, or combinations thereof.

A tenth aspect of the present disclosure may include any one of the first through ninth aspects, where the solid catalyst support comprises sodium titanate nanotubes or potassium titanate nanotubes.

An eleventh aspect of the present disclosure may include any one of the first through tenth aspects, where the RWGS catalyst may be free of chromium.

A twelfth aspect of the present disclosure may include any one of the first through eleventh aspects, and may be directed to a method of making the RWGS catalyst of any one of the first through eleventh aspects, where the method may comprise precipitating the reduced iron oxide and the alkali metal promoter onto surfaces of the solid catalyst support through deposition reductive precipitation.

A thirteenth aspect of the present disclosure may include the twelfth aspect, where the method may comprise dissolving iron (III) ions in a solvent to produce an iron-containing solution; dispersing the catalyst support particles in the iron-containing solution to produce a dispersion; combining a reducing agent and an alkali metal precursor with the dispersion; heat treating the dispersion with the reducing agent and the alkali metal precursor at a temperature and for a time sufficient to reduce the iron in the iron-containing solution to produce the reduced iron oxide in which the iron has the oxidation state less than 3 and precipitate the reduced iron oxide and the alkali metal promoter onto the surfaces of the catalyst support particles; and recovering the RWGS catalyst from the heat-treated dispersion.

A fourteenth aspect of the present disclosure may include the thirteenth aspect, where the dissolving the iron (III) ions in the solvent may comprise combining an iron salt comprising iron in an oxidation state greater than or equal to 3 with the solvent and mixing to dissolve the iron salt in the solvent.

A fifteenth aspect of the present disclosure may include the fourteenth aspect, where the iron salt may be selected from the group consisting of iron (III) sulfate, iron (III) chloride, iron (III) acetate, iron (III) nitrate, iron (III) acetylacetonate, and combinations thereof.

A sixteenth aspect of the present disclosure may include either one of the fourteenth or fifteenth aspects, where the solvent may be selected from the group consisting of ethylene glycol, diethylene glycol, triethylene glycol, butanol, pentanol, hexanol, benzyl alcohol, and combinations thereof.

A seventeenth aspect of the present disclosure may include any one of the thirteenth through sixteenth aspects, where the reducing agent may be selected from the group consisting of hydrazine monohydrate, sodium borohydride, butanol, pentanol, hexanol, benzyl alcohol, and combinations thereof.

An eighteenth aspect of the present disclosure may include any one of the thirteenth through seventeenth aspects, where the alkali metal precursor may comprise sodium hydroxide, potassium hydroxide, sodium hydroxide, rubidium hydroxide, caesium hydroxide, potassium benzoate, potassium acetylacetonate, potassium acetylide, potassium acetyl aminosuccinate, or combinations thereof.

A nineteenth aspect of the present disclosure may include any one of the thirteenth through eighteenth aspects, where the heat treating the dispersion may comprise heating treating the dispersion at a temperature of from 120° C. to 200° C. for a heat treatment period of from 24 hours to 48 hours while mixing.

A twentieth aspect of the present disclosure may include any one of the thirteenth through nineteenth aspects, where recovering the RWGS catalyst from the heat-treated dispersion may comprise separating the RWGS catalyst from the mother liquor of the dispersion through filtration; washing the RWGS catalyst with ethanol or isopropanol, and then drying under vacuum at a temperature of from 50° C. to 100° C. for a period of 24 hours to 48 hours.

A twenty-first aspect of the present disclosure may include any one of the twelfth through twentieth aspects, where the solid catalyst support may comprise sodium titanate, potassium titanate, zirconia, alumina, titania, silica, magnesia, ceria, bentonite clay, or combinations thereof.

A twenty-second aspect of the present disclosure may include any one of the first through eleventh aspects, and may be directed to a process for converting carbon dioxide to carbon monoxide, where the process may comprise contacting a carbon dioxide stream with hydrogen in the presence of the RWGS catalyst of any one of the first through eleventh aspects at a reaction temperature of from 350° C. (623 Kelvin (K)) to 600° C. (873 K), where the contacting may cause the carbon dioxide in the carbon dioxide stream and the hydrogen to undergo a reverse water gas shift reaction to produce carbon monoxide and water.

A twenty-third aspect of the present disclosure may include the twenty-second aspect, comprising contacting the carbon dioxide with hydrogen in a fixed bed reactor comprising the RWGS catalyst.

A twenty-fourth aspect of the present disclosure may include either one of the twenty-second or twenty-third aspects, where the process may have a selectivity for carbon monoxide of greater than or equal to 90%, greater than or equal to 95%, greater than or equal to 98%, or even greater than or equal to 99%.

A twenty-fifth aspect of the present disclosure may include any one of the twenty second through twenty-fourth aspects, wherein the process may have a selectivity for carbon monoxide of 100%.

A twenty-sixth aspect of the present disclosure may include any one of the twenty-second through twenty-fifth aspects, where the process may have a total conversion of carbon dioxide of greater than 5%, greater than or equal to 10%, greater than or equal to 20%, greater than or equal to 30%, greater than or equal to 35%, greater than or equal to 40%, greater than or equal to 45%, greater than or equal to 50%, or even greater than or equal to 55% at a reaction temperature of from 400° C. to 600° C.

A twenty-seventh aspect of the present disclosure may include any one of the twenty-second through twenty-sixth aspects, further comprising, before the contacting, activating the RWGS catalyst.

A twenty-eighth aspect of the present disclosure may include the twenty-seventh aspect, where activating the RWGS catalyst may comprise contacting the RWGS catalyst with a flow of hydrogen at an activation temperature of from 450° C. (723 K) to 550° C. (823 K) for an activation time period of from 3 hours to 5 hours, where activation under the flow of hydrogen further may reduce the iron oxide of the RWGS catalyst.

A twenty-ninth aspect of the present disclosure may include any one of the twenty-second through twenty-eighth aspects, comprising contacting the carbon dioxide stream and the hydrogen in the presence of the RWGS catalyst at a molar ratio of hydrogen to carbon dioxide of from 1 to 6, or from 1 to 5.

A thirtieth aspect of the present disclosure may include any one of the twenty-second through twenty-ninth aspects, comprising contacting the carbon dioxide stream and the hydrogen in the presence of the RWGS catalyst at atmospheric pressure (101.325 kPa).

A thirty-first aspect of the present disclosure may include any one of the twenty-second through thirtieth aspects, comprising contacting the carbon dioxide stream and the hydrogen in the presence of the RWGS catalyst at a gas hourly space velocity (GHSV) of from 3,300 per hour to 13,200 per hour.

A thirty-second aspect of the present disclosure may include any one of the twenty-second through thirty-first aspects, where the RGWS catalyst may be disposed in a reaction zone of a fixed bed reactor and the process may comprise contacting the carbon dioxide stream and the hydrogen in the presence of the RWGS catalyst in the fixed bed reactor to produce a reaction effluent comprising the carbon monoxide and the water.

A thirty-third aspect of the present disclosure may include the thirty-aspect, where the reaction effluent may comprise carbon monoxide, water, unreacted carbon dioxide, and unreacted hydrogen.

A thirty-fourth aspect of the present disclosure may include the thirty-second or thirty-third aspect, further comprising removing water from the reaction effluent to produce a water stream and a product stream, where the product stream may comprise carbon monoxide.

A thirty-fifth aspect of the present disclosure may include the thirty-fourth aspect, where removing the water from the reaction effluent may comprise passing the reaction effluent to a condenser configured to condense the water from the reaction effluent to produce the water stream and the product stream.

A thirty-sixth aspect of the present disclosure may include either one of the thirty-fourth or thirty-fifth aspects, where the product stream further may comprise unreacted carbon dioxide and unreacted hydrogen and the process further may comprise separating the unreacted carbon dioxide from the product stream and recycling the unreacted carbon dioxide back to the fixed bed reactor as at least a portion of the carbon dioxide stream.

A thirty-seventh aspect of the present disclosure may include the thirty-sixth aspect, where separating the unreacted carbon dioxide from the product stream may produce a syngas stream comprising carbon monoxide and unreacted hydrogen.

A thirty-eighth aspect of the present disclosure may include any one of the thirty-sixth or thirty-seventh aspects, further comprising separating the unreacted hydrogen from the product stream and passing the unreacted hydrogen back to the fixed bed reactor.

It is noted that any two quantitative values assigned to a property may constitute a range of that property, and all combinations of ranges formed from all stated quantitative values of a given property are contemplated in this disclosure.

It is noted that one or more of the following claims utilize the term “where” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

Having described the subject matter of the present disclosure in detail and by reference to specific aspects, it is noted that the various details of such aspects should not be taken to imply that these details are essential components of the aspects. Rather, the claims appended hereto should be taken as the sole representation of the breadth of the present disclosure and the corresponding scope of the various aspects described in this disclosure. Further, it will be apparent that modifications and variations are possible without departing from the scope of the appended claims.

What is claimed is:

1. A reverse water gas shift catalyst (RWGS catalyst) for conducting reverse water gas shift reactions to convert carbon dioxide to carbon monoxide, the RWGS catalyst comprising reduced iron oxide and an alkali metal promoter supported on a solid catalyst support, where the solid catalyst support comprises a plurality of catalyst support particles and the reduced iron oxide has iron having an oxidation state of less than 3.

2. The RWGS catalyst of claim 1, where the RWGS catalyst comprises from 4 wt. % to 14 wt. % of the reduced iron oxide based on the total weight of the RWGS catalyst.

3. The RWGS catalyst of claim 1, where the alkali metal promoter comprises an alkali metal selected from the group consisting of lithium (Li), sodium (Na), potassium (K), rubidium (Rb), caesium (Cs), and combinations of these.

4. The RWGS catalyst of claim 1, where the alkali metal promoter comprises an alkali metal oxide selected from the group consisting of Li₂O, Na₂O, K₂O, Rb₂O, Cs₂O, and combinations thereof.

5. The RWGS catalyst of claim 1, where the RWGS catalyst comprises from 4 wt. % to 20 wt. % of the alkali metal promoter based on the total weight of the RWGS catalyst.

6. The RWGS catalyst of claim 1, where the solid catalyst support comprises sodium titanate, potassium titanate, zirconia, alumina, titania, silica, magnesia, ceria, bentonite clay, or combinations thereof.

7. The RWGS catalyst of claim 1, where the solid catalyst support comprises sodium titanate, potassium titanate, or combinations thereof.

8. The RWGS catalyst of claim 1, where the solid catalyst support comprises sodium titanate nanotubes or potassium titanate nanotubes.

9. A method of making the RWGS catalyst of claim 1, the method comprising precipitating the reduced iron oxide and the alkali metal promoter onto surfaces of the solid catalyst support through deposition reductive precipitation.

10. The method of claim 9, where the method comprises:
dissolving iron (III) ions in a solvent to produce an iron-containing solution;
dispersing the catalyst support particles in the iron-containing solution to produce a dispersion;
combining a reducing agent and an alkali metal precursor with the dispersion;
heat treating the dispersion with the reducing agent and the alkali metal precursor at a temperature and for a time sufficient to reduce the iron in the iron-containing solution to produce the reduced iron oxide in which the iron has the oxidation state less than 3 and precipitate the reduced iron oxide and the alkali metal promoter onto the surfaces of the catalyst support particles; and
recovering the RWGS catalyst from the heat-treated dispersion.

11. The method of claim 10, where the dissolving the iron (III) ions in the solvent comprises combining an iron salt comprising iron in an oxidation state equal to 3 with the solvent and mixing to dissolve the iron salt in the solvent, wherein:
the iron salt is selected from the group consisting of iron (III) sulfate, iron (III) chloride, iron (III) acetate, iron (III) nitrate, iron (III) acetylacetonate, and combinations thereof; and
the solvent is selected from the group consisting of ethylene glycol, diethylene glycol, triethylene glycol, butanol, pentanol, hexanol, benzyl alcohol, and combinations thereof.

12. The method of claim 10, where:
the reducing agent is selected from the group consisting of hydrazine monohydrate, sodium borohydride, butanol, pentanol, hexanol, benzyl alcohol, and combinations thereof; and
the alkali metal precursor comprises sodium hydroxide, potassium hydroxide, sodium hydroxide, rubidium hydroxide, caesium hydroxide, potassium benzoate,
potassium acetylacetonate, potassium acetylide, potassium acetyl aminosuccinate, or combinations thereof.

13. The method of claim 10, where the solid catalyst support comprises sodium titanate, potassium titanate, or combinations thereof.

14. A process for converting carbon dioxide to carbon monoxide, the process comprising contacting a carbon dioxide stream with hydrogen in the presence of the RWGS catalyst of claim 1 at a reaction temperature of from 350° C. (623 Kelvin (K)) to 600° C. (873 K), where the contacting causes the carbon dioxide in the carbon dioxide stream and the hydrogen to undergo a reverse water gas shift reaction to produce carbon monoxide and water.

15. The process of claim 14, where the process has a selectivity for carbon monoxide of greater than or equal to 90%.

16. The process of claim 14, further comprising, before the contacting, activating the RWGS catalyst, where activating the RWGS catalyst comprises contacting the RWGS catalyst with a flow of hydrogen at an activation temperature of from 450° C. (723 K) to 550° C. (823 K) for an activation time period of from 3 hours to 5 hours, where activation under the flow of hydrogen further reduces the iron oxide of the RWGS catalyst.

17. The process of claim 14, comprising contacting the carbon dioxide stream and the hydrogen in the presence of the RWGS catalyst at a molar ratio of hydrogen to carbon dioxide of from 1 to 6, or from 1 to 5.

18. The process of claim 14, comprising contacting the carbon dioxide stream and the hydrogen in the presence of the RWGS catalyst at a gas hourly space velocity (GHSV) of from 3,300 per hour to 13,200 per hour.

19. The process of claim 14, where the RGWS catalyst is disposed in a reaction zone of a fixed bed reactor and the process comprises contacting the carbon dioxide stream and the hydrogen in the presence of the RWGS catalyst in the fixed bed reactor to produce a reaction effluent comprising the carbon monoxide, the water, unreacted carbon dioxide, and unreacted hydrogen.

20. The process of claim 19, further comprising separating the unreacted carbon dioxide, the unreacted hydrogen, or both from the product stream and recycling the unreacted carbon dioxide, the unreacted hydrogen, or both back to the fixed bed reactor.
